(19) United States
(12) Patent Application Publication
(10) Pub. No.: US 2023/0406760 A1
(43) Pub. Date: Dec. 21, 2023

(54) PROCESS FOR MAKING A COATED ARTICLE

(71) Applicant: 3M INNOVATIVE PROPERTIES COMPANY, St. Paul, MN (US)

(72) Inventors: Steven J. McMan, Stillwater, MN (US); Jon P. Nietfeld, Woodbury, MN (US); Chad M. Amb, Roberts, WI (US); Audrey A. Eigner, White Bear Lake, MN (US); Kevin R. Ansell, Mahtomedi, MN (US)

(21) Appl. No.: 18/036,131

(22) PCT Filed: Nov. 10, 2021
(86) PCT No.: PCT/IB2021/060379

§ 371 Date: May 9, 2023

Related U.S. Application Data
(60) Provisional application No. 63/112,037, filed on Nov. 10, 2020.

(51) Int. Cl. C03C 17/34

(52) U.S. Cl. CPC C03C 17/3405; C03C 2217/445; C03C 2217/48

(57) ABSTRACT

The process includes applying a first composition on at least the portion of a siliceous substrate and subsequently applying a second composition on at least a portion of the first composition. The first composition includes an amine-reactive organosilane compound that is at least partially hydrolyzed. The second coating composition includes at least one of an amino-functional silane or cyclic azasilane and a condensation-curable polyorganosiloxane having divalent units represented by formula (I). The use of the first composition to improve the durability of the second composition, a kit including the first composition and the second composition, and a coated article made by the process are also described.

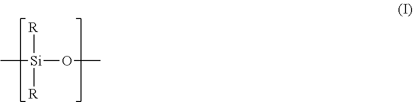

### CROSS-REFERENCE TO RELATED APPLICATION

This application claims priority to U.S. Provisional Application No. 63/112,037, filed Nov. 10, 2020, the disclosure of which is incorporated by reference in its entirety herein.

### BACKGROUND

In normal use, surfaces of motor vehicles, for example, are regularly exposed to weather effects such as rain, snow, sleet, ice formation, and other precipitation, as well as environmental contaminants (e.g., dirt, grime, dust, air-borne pollutants, road surface residue, and bird and other animal waste). It is desirable to maintain the physical condition of these vehicles by cleaning or washing them and, in some cases, subsequently waxing and polishing or buffing them.

Many products that are intended to improve or restore a vehicle's finish are commercially available. A coating composition said to be useful for imparting water repellency, gloss, and durability to a surface, particularly on an automobile or other vehicle is described in U.S. Pat. Appl. Pub. No. 2017/0349783 (Kirino). A highly abrasion-resistant vehicle paint is described in U.S. Pat. Appl. Pub. No. 2011/0082254 (Sepeur et al.).

Certain compositions including polyorganosiloxanes having hydrolyzable groups have been reported to be useful for automotive coatings and are described in U.S. Pat. No. 9,334,408 (Onai), U.S. Pat. Appl. Pub. No. 2008/0026163 (Hamaguchi et al.), Int. Pat. Appl. Pub. No. WO 2014/120601 (Harkness et al.), and Japanese Patent Application 2018/080291 A, published May 24, 2018.

### SUMMARY OF THE DISCLOSURE

In one aspect, the present disclosure provides a process for making a coated article. The process includes applying a first composition on at least the portion of a siliceous substrate and subsequently applying a second composition on at least a portion of the first composition. The first composition includes an amine-reactive organosilane compound that is at least partially hydrolyzed. The second coating composition includes at least one of an amino-functional silane or cyclic azasilane and a condensation-curable polyorganosiloxane having divalent units represented by formula

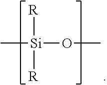

In the condensation-curable polyorganosiloxane, each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In another aspect, the present disclosure provides a coated article made by the process.

In another aspect, the present disclosure provides the use of a first composition to improve durability of a second composition. The first composition comprises an amine-reactive organosilane compound that is at least partially hydrolyzed. The second composition comprises at least one of an amino-functional silane or cyclic azasilane and a condensation-curable polyorganosiloxane having divalent units represented by formula

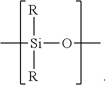

In the condensation-curable polyorganosiloxane, each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In another aspect, the present disclosure provides a kit. The kit includes a container of a first composition and a container of a second composition. The first composition includes an at least partially hydrolyzed amine-reactive organosilane compound. The second composition includes at least one of an amino-functional silane or cyclic azasilane and a condensation-curable polyorganosiloxane having divalent units represented by formula

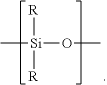

In the condensation-curable polyorganosiloxane, each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In some embodiments, compositions of the present disclosure can provide high receding contact angles to water and low coefficients of friction even after scrubbing. Typically, and advantageously, the process provides a receding higher contact angle after scrubbing than a process in which only the second composition is applied to the siliceous substrate.

As used herein:

The term “aliphatic group” means a saturated or unsaturated linear, branched, or cyclic hydrocarbon group. This term is used to encompass alkyl, alkenyl, and alkynyl groups, for example.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Cyclic groups can be monocyclic or polycyclic and typically have from 3 to 10 ring carbon atoms. Examples of “alkyl” groups include methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl.

The term “alkylene” is the divalent or trivalent form of the “alkyl” groups defined above.

The term “amino group” is a functional group that consists of a nitrogen atom attached by single bonds to hydrogen atoms, alkyl groups, aryl groups, or a combination of these three. Primary amino groups include two hydrogen atoms bonded to the nitrogen, secondary amino groups include one hydrogen atom bonded to the nitrogen, and tertiary amino groups include no hydrogen atoms bonded to the nitrogen.

The term “amine-reactive organosilane compound” refers to a compound that interacts or reacts with the amino-functional silane or cyclic azasilane in the second composition. The amine-reactive organosilane compound and the amino-functional silane or cyclic azasilane may react to form a covalent bond or a hydrogen bond or may interact through Van Der Waals forces, for example. Examples of reactions forming covalent bonds include ring opening of an epoxide by an amino group, formation of a urethane by reaction of an amino group with an isocyanate, displacement of a chloro group by an amine nucleophile, and additional of an amino group to an alpha-beta unsaturated carbonyl compound.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms and optionally contain at least one heteroatom (i.e., O, N, or S). In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, anthracyl, and pyridinyl.

The term “arylene” is the divalent form of the “aryl” groups defined above.

“Arylalkylene” refers to an “alkylene” moiety to which an aryl group is attached.

“Arylalkylenyl” refers to a terminal aryl group attached to an “alkylene” moiety.

The term “catenated heteroatom” means an atom other than carbon (for example, oxygen, nitrogen, or sulfur) that replaces one or more carbon atoms in a carbon chain (for example, so as to form a carbon-heteroatom-carbon chain or a carbon-heteroatom-heteroatom-carbon chain).

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent. A “curable composition” refers to a composition that can be cured.

The term “epoxy group” refers to a functional group that consists of an oxygen atom joined by single bonds to two adjacent carbon atoms, thus forming the three-membered epoxide ring.

The term “fluoro-” (for example, in reference to a group or moiety, such as in the case of “fluoroalkylene” or “fluoroalkyl” or “fluorocarbon”) or “fluorinated” can mean partially fluorinated such that there is at least one carbon-bonded hydrogen atom or perfluorinated.

The term “hydrolyzable group” or “hydrolyzable functional group” refer to a group that can react with water under conditions of atmospheric pressure. The reaction with water may optionally be catalyzed by acid or base. The hydrolyzable group is often converted to a hydroxyl group when it reacts. The hydroxyl group often undergoes further reactions (e.g., condensation reactions). As used herein, the term is often used in reference to one or more groups bonded to a silicon atom in a silyl group. Suitable hydrolyzable groups include halogen (e.g., iodo, bromo, chloro); alkoxy (e.g., —O-alkyl), aryloxy (e.g., —O-aryl), acyloxy (e.g., —O—C(O)-alkyl), amino (e.g., —N(R¹)(R²), wherein each R¹ or R² is independently hydrogen or alkyl), polyalkyleneoxy; and oxime (e.g., —O—N═C—(R¹)(R²).

The term “halogen” refers to a halogen atom or one or more halogen atoms, including chlorine, bromine, iodine, and fluorine atoms or fluoro, chloro, bromo, or iodo substituents.

The term “(meth)acrylate group” is a functional group that refers to an acrylate group of the formula CH₂═CH—C(O)O— and a methacrylate group of the formula CH₂═C(CH₃)—C(O)O—.

The term “oligomer” means a molecule that comprises at least two repeat units and that has a molecular weight less than its entanglement molecular weight; such a molecule, unlike a polymer, exhibits a significant change in properties upon the removal or addition of a single repeat unit.

The term “oxy” means a divalent group or moiety of formula —O—.

The term “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

The term “perfluoroether” means a group or moiety having two saturated or unsaturated perfluorocarbon groups (linear, branched, cyclic (e.g., alicyclic), or a combination thereof) linked with an oxygen atom (that is, there is at least one catenated oxygen atom).

The term “polyfluoropolyether” means a group having three or more saturated or unsaturated perfluorocarbon groups (linear, branched, cyclic (e.g., alicyclic), or a combination thereof) linked with oxygen atoms (that is, there are at least two catenated oxygen atoms).

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

Reference throughout this specification to “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION

The substrate useful in process of the present disclosure is a siliceous substrate. The siliceous substrate can be glass, crystalline ceramic, glass-ceramic, and combinations thereof. In some embodiments, the substrate comprises automotive glass. The substrate can be, for example, a windshield, side glass, back glass, or combination thereof.

The process of the present disclosure includes applying a first composition on at least the portion of the siliceous substrate. The first composition includes an amine-reactive organosilane compound, wherein the amine-reactive organosilane compound is at least partially hydrolyzed. In some embodiments, the amine-reactive organosilane compound is at least partially hydrolyzed and condensed.

In some embodiments, the amine-reactive organosilane compound is represented by formula I.

R³_{f}[Si(X)_{4-f}]_{g} I

wherein g is 1 to 6; f is 1 or 2; each R³ is monovalent or multivalent, and is independently alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein at least one R³ is substituted with at least one epoxy, (meth)acrylate, isocyanate (i.e., —N═C═O), thiocyanate (i.e., —S═C═N), chloro (i.e., —Cl), or a combination thereof, and each X is a hydrolysable group. R¹¹ is hydrogen, alkyl, aryl, or arylalkylenyl, wherein aryl and arylalkylenyl are unsubstituted or substituted by at least one alkyl, alkoxy, or combination thereof. In some embodiments, R¹¹ is hydrogen or alkyl, for example, having 1 to 4 carbon atoms (e.g., methyl, ethyl, n-propyl, isopropyl, n-butyl, isobutyl, or sec-butyl). In some embodiments, R¹¹ is methyl or hydrogen.

In some embodiments, X is independently a halide (i.e., fluoride, chloride, bromide, or iodine), hydroxyl (i.e., —OH), alkoxy (e.g., —O-alkyl), aryloxy (e.g., —O-aryl), acyloxy (e.g., —O—C(O)-alkyl), amino (e.g., —N(R¹)(R²), wherein each R¹ or R² is independently hydrogen or alkyl), oxime (e.g., —O—N═(R¹)(R²)) or polyalkyleneoxy (e.g., -[EO]ₕ-[R⁹O]ᵢ-[EO]ₕ—R⁹′ or —[R⁹O]ᵢ-[EO]ₕ—[R⁹O]ᵢ—R⁹′, wherein EO represents —CH₂CH₂O—; each R⁹O independently represents —CH(CH₃)CH₂O—, —CH₂CH(CH₃)O—, —CH(CH₂CH₃)CH₂O—, —CH₂CH(CH₂CH₃)O—, or —CH₂C(CH₃)₂O— (in some embodiments, —CH(CH₃)CH₂O— or —CH₂CH(CH₃)O—), each h is independently a number from 1 to 150 (in some embodiments, from 7 to about 150, 14 to about 125, 5 to 15, or 9 to 13); and each i is independently a number from 0 to 55 (in some embodiments, from about 21 to about 54, 15 to 25, 9 to about 25, or 19 to 23); and wherein R⁹′ is hydrogen or alkyl having up to four carbon atoms), with the proviso that at least one X is hydroxyl. Alkoxy and acyloxy are optionally substituted by halogen, and aryloxy is optionally substituted by halogen, alkyl (e.g., having up to 4 carbon atoms), or haloalkyl. In some embodiments, alkoxy and acyloxy have up to 18 (or up to 12, 6, or 4) carbon atoms. In some embodiments, aryloxy has 6 to 12 (or 6 to 10) carbon atoms. In some embodiments, X is independently selected from the group consisting of halide, hydroxyl, alkoxy, aryloxy, and acyloxy, with the proviso that at least one X is hydroxyl. In some embodiments, X is independently hydroxyl, alkoxy, amino, acetoxy, aryloxy, or halogen, with the proviso that at least one X is hydroxyl. In some embodiments, X is independently selected from the group consisting of hydroxyl, halide (e.g., chloride), amino, and alkoxy having up to ten carbon atoms, with the proviso that at least one X is hydroxyl. In some of these embodiments, X is independently alkoxy having from 1 to 6 (e.g., 1 to 4) carbon atoms. In some of these embodiments, each X is independently methoxy or ethoxy. In some embodiments, X of formula I is independently —OR¹, wherein R¹ is hydrogen or a (C₁-C₁₈)alkyl, or —NR¹R² (wherein each R¹ and R² is independently hydrogen or a (C₁-C₁₈)alkyl, in some embodiments, (C₁-C₁₂)alkyl, (C₁-C₈)alkyl, or (C₁-C₄)alkyl, with the proviso that at least one R¹ is hydrogen. In some embodiments, X is independently OR¹ (wherein R¹ hydrogen or a (C₁-C₁₈)alkyl), in some embodiments, (C₁-C₁₂)alkyl, (C₁-C₈)alkyl, or (C₁-C₄)alkyl, with the proviso that at least one R¹ is hydrogen. In some embodiments, each R¹ is hydrogen.

In formula I, R³ can include a straight chain, branched, or cyclic group, or a combination thereof. In some embodiments, each R³ independently includes 1 to 18, 1 to 12, 1 to 8, 1 to 6, or 2 to 6 carbon atoms. In some embodiments, each R³ includes at least one catenated oxygen atom. Each R³ includes at least one epoxy, (meth)acrylate, isocyanate, thiocyanate, or chloro group or a combination thereof. In some embodiments, each R³ includes at least one epoxy, (meth)acrylate, isocyanate, or chloro group or a combination thereof. In some embodiments, each R³ includes at least one epoxy.

In some embodiments of formula I, g is 1 or 2. In some embodiments, g is 1.

In some embodiments of formula I, f is 1.

Useful silanes represented by formula I include methacryloxypropyltrimethoxysilane and 3-glycidoxypropyltrimethoxysilane.

In some embodiments, the amine-reactive organosilane in the first composition is represented by formula II.

L-R^{3b}—Si(X)_{3-f′}(R^{3a})_{f′} II

In formula II, X is as defined above in any of its embodiments described in connection with formula I. R^{3a} is monovalent alkyl, aryl, arylalkylenyl, wherein alkyl and arylalkylenyl are each uninterrupted or interrupted with at least one catenated —O—, —N(R¹¹)—, —S—, —P—, —Si— or combination thereof, and wherein aryl and arylalkylenyl are each unsubstituted or substituted by alkyl or alkoxy. R^{3b} is divalent alkylene, arylene, or arylalkylene, wherein alkylene and arylalkylene are each uninterrupted or interrupted with at least one catenated —O—, —N(R¹¹)—, —S—, —P—, —Si— or combination thereof, and wherein arylene and arylalkylene are each unsubstituted or substituted by alkyl or alkoxy. R¹¹ is as defined above in connection with Formula I in any of its embodiments. L is epoxy, (meth)acrylate, isocyanate, thiocyanate, or chloro. In some embodiments, L is epoxy, (meth)acrylate, isocyanate, or chloro. In some embodiments, L is epoxy. In formula II, f is 0 or 1. In some embodiments, f is 0. In some embodiments, R^{3b} is alkylene having 1 to 18, 1 to 12, 1 to 8, 1 to 6, or 2 to 6 carbon atoms and is uninterrupted or interrupted with at least one catenated —O— or —N(R¹¹)— or combination thereof. In some embodiments, R^{3b} is alkylene having 2 to 6 carbon atoms. Useful silanes represented by formula II include methacryloxypropyltrimethoxysilane and 3-glycidoxypropyltrimethoxysilane.

In some embodiments, the amine-reactive organosilane in the first composition can be at least partially hydrolyzed, in some embodiments, at least partially hydrolyzed and condensed. Such compounds may be represented by formula III.

X—[Si(R^{3c})(X)—O]_{r″}—Si(R^{3c})(X)₂ III

In formula III, r″ is 1 to 20, X is as defined above in any of its embodiments in connection with formula I, and each R^{3c} is independently monovalent alkyl, aryl, arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each substituted with at least one epoxy, (meth)acrylate, isocyanate, thiocyanate, chloro, or a combination thereof. R¹¹ is as defined above in connection with formula I in any of its embodiments. In some embodiments, each R^{3c} is independently alkylene having 1 to 18, 1 to 12, 1 to 6, or 2 to 6 carbon atoms and is uninterrupted or interrupted with at least one catenated —O— or —N(H)— or combination thereof, and at least some R^{3c} groups are substituted with at least one epoxy, (meth)acrylate, isocyanate, chloro, or a combination thereof. In some embodiments, each R^{3c} is independently alkylene having 2 to 6 carbon atoms uninterrupted or interrupted with at least one catenated —O— and substituted with epoxy.

In some embodiments, the first composition includes at least 0.01 wt. %, at least 0.1 wt. %, or at least 1 wt. % of the amine-reactive organosilane compound, including any of those described above, based on the total weight of the first composition. In some embodiments, the composition includes up to 10 wt. %, up to 5 wt. %, or up to 1 wt. % of amine-reactive organosilane, including any of those described above, based on the total weight of the composition.

In some embodiments, the first composition useful for practicing the present disclosure includes water. In some embodiments, the water is present in the first composition in a range from 0.01 percent to 5 percent (in some embodiments, 0.05 to 1, 0.05 to 0.5, or 0.1 to 0.5 percent) by weight, based on the total weight of the first composition. Water may be added to the first composition separately or may be added as part of an aqueous acidic solution (e.g., concentrated hydrochloric acid is 37% by weight of the acid in water). In some embodiments, the first composition is a water-based composition or an emulsion (e.g., an oil-in-water emulsion). In these embodiments, the first composition can include up to 99 wt. %, up to 95 wt. %, or up to 90 wt. % water, based on the total weight of the first composition. In some of these embodiments, the first composition includes at least 25 wt. %, 50 wt. %, at least 60 wt. %, or at least 75 wt. % water, based on the total weight of the first composition. Purified or deionized water may be useful.

In some embodiments, the first composition includes organic solvent. As used herein, the term “organic solvent” includes a single organic solvent and a mixture of two or more organic solvents. Suitable organic solvents include aliphatic alcohols (e.g., methanol, ethanol, and isopropanol); ketones (e.g., acetone, 2-butanone, and 2-methyl-4-pentanone); esters (e.g., ethyl acetate, butyl acetate, and methyl formate); ethers (e.g., diethyl ether, diisopropyl ether, methyl t-butyl ether, 2-methoxypropanol, and dipropyleneglycol monomethylether (DPM)); and hydrocarbons such as alkanes (e.g., heptane, decane, and paraffinic solvents). In some embodiments, the organic solvent is methanol, ethanol, isopropanol, or a mixture thereof. In some embodiments, the organic solvent is isopropanol.

In the first composition, it is believed that the amino-reactive group can react with an amine group in the second composition, described below. At least some of the X groups in the compounds of formula I, II, and III, for example, are silanol groups. The water necessary for hydrolysis of hydrolyzable X groups to form silanol groups may be added to the first composition, may be adventitious water in the solvent or adsorbed to the surface of the substrate, or may be present in the atmosphere to which the amine-reactive organosilane is exposed (e.g., an atmosphere having a relative humidity of at least 10%, 20%, 30%, 40%, or even at least 50%). The silanol groups can then react with —OH groups on the surface of the siliceous substrate to form siloxane bonds. Remaining silanol groups may self-condense or react with the silanols or hydrolysable groups (e.g., alkoxy, acyloxy, or halogen) on the condensation-curable polyorganosiloxanes in the second composition to form siloxane bonds.

In embodiments of a coated article made from the process of the present disclosure, at least a portion of the siliceous substrate is in contact with or bonded to the amine-reactive organosilane compound. The amine-reactive organosilane compound forms a thin layer on at least a portion of the siliceous substrate, and the formed layer is believed to include at least one siloxane bond shared with the siliceous substrate. All the silanes in the amine-reactive silane may be converted to siloxanes, either by condensation with the siliceous substrate or by self-condensation, or some unreacted silanes or uncondensed silanols may remain on the amine-reactive organosilane. In the coated article, hydrolysable groups or silanol groups in at least one of the condensation-curable polyorganosiloxane or at least one of the amino-functional silane or cylic azasilane may react with such groups in the amine-reactive organosilane, forming at least one siloxane bond with the amine-reactive organosilane. All the silanes in the condensation-curable polyorganosiloxanes may be converted to siloxanes, either by condensation with the amine-reactive organosilane or the siliceous substrate or by self-condensation, or some unreacted silanes or uncondensed silanols may remain on the condensation-curable polyorganosiloxane. Thus, in some embodiments of the treated article according to the present disclosure, the second layer on the siliceous substrate is a partial condensate of the amine-reactive organosilane and the condensation-curable polyorganosiloxane.

Condensation-curable polyorganosiloxanes useful in the second composition include oligomers and polymers that can be linear or branched. Useful oligomers and polymers include those that have random, alternating, block, or graft structures, or a combination thereof. When the composition is stored and applied, it typically does not have a network, cage, or crosslinked structure.

The second composition of the present disclosure includes a condensation-curable polyorganosiloxane comprising divalent units independently represented by formula X:

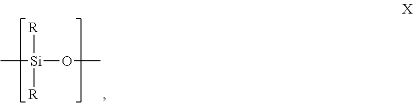

wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof (in some embodiments, —O—, —S—, and combinations thereof, or —O—), wherein aryl, arylalkylenyl, and heterocycloalkyenyl are unsubstituted or substituted by at least one alkyl, alkoxy, halogen, or combination thereof. R¹¹ is hydrogen, alkyl, aryl, or arylalkylenyl, wherein aryl and arylalkylenyl are unsubstituted or substituted by at least one alkyl, alkoxy, or combination thereof. In some embodiments, R¹¹ is hydrogen or alkyl, for example, having 1 to 4 carbon atoms (e.g., methyl, ethyl, n-propyl, isopropyl, n-butyl, isobutyl, or sec-butyl). In some embodiments, R¹¹ is methyl or hydrogen. In some embodiments, the halogen or halogens on the alkyl, aryl, arylalkylenyl, or heterocycloalkylenyl groups is fluoro. R is generally considered a non-hydrolyzable group, which is not capable of being hydrolyzed under the conditions described above for hydrolyzing hydrolyzable groups.

When R is fluorinated, in some embodiments, R is R_{f}CⱼH₂ⱼ—, wherein j is an integer of 2 to 8 (or 2 to 3), and R_{f} is a fluorinated or perfluorinated alkyl group having 1 to 12 carbon atoms (or 1 to 6 carbon atoms); in some embodiments, R is R_{f}′CⱼH₂ⱼ—, wherein j is an integer of 2 to 8 (or 2 to 3), and R_{f}′ is a fluorinated or perfluorinated polyether group having 1 to 45 carbon atoms (in some embodiments, 1 to 30 carbon atoms), aryl, and combinations thereof. In some embodiments, R_{f} is a perfluoroalkyl group; and/or R_{f}′ is a perfluoropolyether group. Perfluoropolyether groups that can be linear, branched, cyclic, or a combination thereof. The perfluoropolyether group can be saturated or unsaturated (in some embodiments, saturated). Examples of useful perfluoropolyether groups include those that have —(CₚF₂ₚ)—, —(CₚF₂ₚO)—, —(CF(RF)O)—, —(CF(RF)CₚF₂ₚO)—, —(CₚF₂ₚCF(RF)O)—, or —(CF₂CF(RF)O)— repeating units or combinations thereof, wherein p is an integer of 1 to 10 (or 1 to 8, or 1 to 6, or 1 to 4, or 1 to 3); RF is selected from perfluoroalkyl, perfluoroether, perfluoropolyether, and perfluoroalkoxy groups that are linear, branched, cyclic, or a combination thereof and that have up to 12 carbon atoms, up to 10 carbon atoms, up to 8 carbon atoms, up to 6 carbon atoms, up to 4 carbon atoms, or up to 3 carbon atoms) and/or up to 4 oxygen atoms, up to 3 oxygen atoms, up to 2 oxygen atoms, or zero or one oxygen atom. In these perfluoropolyether structures, different repeating units can be combined in a block, alternating, or random arrangement to form the perfluoropolyether group.

The terminal group of the perfluoropolyether group can be (CₚF₂ₚ₊₁)— or (CₚF₂ₚ₊₁O)—, for example, wherein p is as defined above. Examples of useful perfluoropolyether groups include C₃F₇O(CF(CF₃)CF₂O)_{n″}CF(CF₃)—, C₃F₇O(CF₂CF₂CF₂O)_{n″}CF₂CF₂—, CF₃O(C₂F₄O)_{n″}CF₂—, CF₃O(CF₂O)_{n″}C₂F₄O)_{q}CF₂—, and F(CF₂)₃O(C₃F₆O)_{q}(CF₂)₃—, wherein n″ has an average value of 0 to 50, or 1 to 50, or 3 to 30, or 3 to 15, or 3 to 10; and q has an average value of 0 to 50, or 3 to 30, or 3 to 15, or 3 to 10.

In some embodiments, the perfluoropolyether group comprises at least one divalent hexafluoropropyleneoxy group (—CF(CF₃)—CF₂O—). Perfluoropolyether groups can include F[CF(CF₃)CF₂O]ₙCF(CF₃)— (or, as represented above, C₃F₇O(CF(CF₃)CF₂O)ₙCF(CF₃), where n+1=a), wherein a has an average value of 4 to 20. Such perfluoropolyether groups can be obtained through the oligomerization of hexafluoropropylene oxide.

In some embodiments, each R is independently alkyl, aryl, or alkyl substituted by fluoro and optionally interrupted by at least one catenated —O— group. Suitable alkyl groups for R in formula X typically have 1 to 10, 1 to 6, or 1 to 4 carbon atoms. Examples of useful alkyl groups include methyl, ethyl, isopropyl, n-propyl, n-butyl, and iso-butyl. In some embodiments, each R is independently alkyl having up to six (in some embodiments, up to 4, 3, or 2) carbon atoms, F[CF(CF₃)CF₂O]ₐCF(CF₃)CⱼH₂ⱼ— (wherein j is an integer of 2 to 8 (or 2 to 3) and a has an average value of 4 to 20), C₄F₉C₃H₆—, C₄F₉C₂H₄—, C₄F₉OC₃H₆—, C₆F₁₃C₃H₆—, CF₃C₃H₆—, CF₃C₂H₄—, phenyl, benzyl, or C₆H₅C₂H₄—. In some embodiments, each R is non-fluorinated. In some embodiments, each R is independently methyl or phenyl. In some embodiments, each R is methyl.

Condensation-curable refers polyorganosiloxanes having functional groups that can condense to form a crosslinked network of polymer chains joined together by siloxane bonds. For example, two molecules of polyorganosiloxanes having silanol groups, hydrolysable groups, or a combination thereof can condense to form a crosslinked network of polymer chains joined together by siloxane bonds. In some embodiments, the condensation-curable polyorganosiloxane in the second composition comprises more than one (in some embodiments, at least 2, 2.1, 2.2, 2.3, 2.4, 2.5, 2.6, 2.7, 2.8, 2.9, 3, or more) functional group selected from the group consisting of silanol, hydrolyzable silane, or a combination thereof. The more than one (in some embodiments, at least 2, 2.1, 2.2, 2.3, 2.4, 2.5, 2.6, 2.7, 2.8, 2.9, 3, or more) silanol, hydrolyzable silane, or combination thereof may be a pendent group, terminal group, or a combination of pendent and terminal groups. In some embodiments, the condensation-curable polyorganosiloxane includes one or two terminal silanol groups. In some embodiments, the condensation-curable polyorganosiloxane includes at least one pendant silanol group.

In some embodiments, the condensation-curable polyorganosiloxane in the second composition has more than one (in some embodiments, at least 2, 2.1, 2.2, 2.3, 2.4, 2.5, 2.6, 2.7, 2.8, 2.9, 3, or more) —Si(Y)ₚ(R)₃₋ₚ group, wherein Y is hydroxyl or a hydrolyzable group, R is as defined above in any of its embodiments, and p is 1, 2, or 3 (in some embodiments, 2 or 3, or 3). Suitable hydrolyzable groups include alkoxy (e.g., —O-alkyl), aryloxy (e.g., —O-aryl), acyloxy (e.g., —O—C(O)-alkyl), amino (e.g., —N(R¹)(R²), wherein each R¹ or R² is independently hydrogen or alkyl), oxime (e.g., —O—N═C(R¹)(R²); or polyalkyleneoxy (e.g., -[EO]ₕ—[R⁹O]ᵢ-[EO]ₕ—R⁹′ or —[R⁹O]ᵢ-[EO]ₕ—[R⁹O]ᵢ—R⁹, wherein EO represents —CH₂CH₂O—; each R⁹O independently represents —CH(CH₃)CH₂O—, —CH₂CH(CH₃)O—, —CH(CH₂CH₃)CH₂O—, —CH₂CH(CH₂CH₃)O—, or —CH₂C(CH₃)₂O— (in some embodiments, —CH(CH₃)CH₂O— or —CH₂CH(CH₃)O—), each h is independently a number from 1 to 150 (in some embodiments, from 7 to about 150, 14 to about 125, 5 to 15, or 9 to 13); and each i is independently a number from 0 to 55 (in some embodiments, from about 21 to about 54, 15 to 25, 9 to about 25, or 19 to 23); and wherein R⁹′ is hydrogen or alkyl having up to four carbon atoms). Alkoxy and acyloxy are optionally substituted by halogen, and aryloxy is optionally substituted by halogen, alkyl (e.g., having up to 4 carbon atoms), or haloalkyl. In some embodiments, alkoxy and acyloxy have up to 18 (or up to 12, 6, or 4) carbon atoms. In some embodiments, aryloxy has 6 to 12 (or 6 to 10) carbon atoms. In some embodiments, each Y is independently alkoxy, aryloxy, or acyloxy. In some embodiments, each Y is independently alkoxy having up to ten carbon atoms. In some of these embodiments, each Y is independently alkoxy having from 1 to 6 (e.g., 1 to 4) carbon atoms. In some of these embodiments, each Y is independently methoxy or ethoxy. In the process of the present disclosure, typically at least some of the hydrolysable groups are hydrolyzed to hydroxyl groups.

The more than one (in some embodiments, at least 2, 2.1, 2.2, 2.3, 2.4, 2.5, 2.6, 2.7, 2.8, 2.9, 3, or more) —Si(Y)ₚ(R)₃₋ₚ group may be pendent groups, terminal groups, or a combination of pendent and terminal groups. In some embodiments, the —Si(Y)ₚ(R)₃₋ₚ groups are pendent groups. In some embodiments, the condensation-curable polyorganosiloxane is terminated with —Si(R)₃ groups, wherein R is defined as above in any of its embodiments. In some embodiments, the condensation-curable polyorganosiloxane has up to 10, 9, 8, 7, 6, or 5 —Si(Y)ₚ(R)₃₋ₚ groups. Since polyorganosiloxanes typically include a distribution of molecular weights and structures, it should be understood that the condensation-curable polyorganosiloxane has an average of more than one —Si(Y)ₚ(R)₃₋ₚ group in the polymer. In some embodiments, the ratio of divalent units represented by formula X to —Si(Y)ₚ(R)₃₋ₚ groups is at least 4, 5, 10 and up to 400, 300, 200, 100, or 75.

In some embodiments, the condensation-curable polyorganosiloxane in the second composition comprises (m) terminal units represented by formula -Q-Si(Y)ₚ(R)₃₋ₚ and (n) divalent units represented by formula XI:

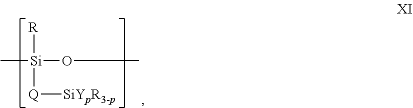

wherein (n) is at least 1, (m) is 0, 1, 2, or more, and (m)+(n) is greater than one (in some embodiments, at least 2, 2.1, 2.2, 2.3, 2.4, 2.5, 2.6, 2.7, 2.8, 2.9, 3, or more). In some embodiments, (m)+(n) is in a range from 3 to 10, 3 to 8, or 3 to 6. In some embodiments, the condensation-curable polyorganosiloxane includes the divalent units represented by formula XI. In formula XI, each R is independently as defined above for a divalent unit of formula X, each Y and p as defined above in any of its embodiments, and each Q is independently alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether (i.e., —O—), thioether (i.e., —S—), amine (i.e., —NR¹¹—), amide (i.e., —N(R¹¹)—C(O)— or —C(O)—N(R¹¹)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R¹¹)N—C(O)—O— or —O—C(O)—N(R¹¹)—, thiocarbamate (i.e., —N(R¹¹)—C(O)—S— or —S—C(O)—N(R¹¹)—, urea (i.e., —(R¹¹)N—C(O)—N(R¹¹)—), thiourea (i.e., —(R¹¹)N—C(S)—N(R¹¹)). In any of these groups that include an R¹¹, R¹¹ is hydrogen, alkyl, aryl, or arylalkylenyl, wherein aryl and arylalkylenyl are unsubstituted or substituted by at least one alkyl, alkoxy, or combination thereof. In some embodiments, R¹¹ is hydrogen or alkyl, for example, having 1 to 4 carbon atoms (e.g., methyl, ethyl, n-propyl, isopropyl, n-butyl, isobutyl, or sec-butyl). In some embodiments, R¹¹ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—). In some embodiments, each Q is independently alkylene that is optionally at least one of interrupted or terminated by at least one ether, thioether, or combination thereof. The alkylene can have 1 to 10, 1 to 6, or 1 to 4 carbon atoms. In some embodiments, Q is alkylene having 1 to 10, 1 to 6, 1 to 4, 1 to 3, or 1 to 2 carbon atoms. In some embodiments, Q is a poly(alkylene oxide) group. Suitable poly(alkylene oxide) groups include those represented by formula (OR¹⁰)_{a′}, in which each OR¹⁰ is independently —CH₂CH₂O—, —CH(CH₃)CH₂O—, —CH₂CH₂CH₂O—, —CH₂CH(CH₃)O—, —CH₂CH₂CH₂CH₂O—, —CH(CH₂CH₃)CH₂O—, —CH₂CH(CH₂CH₃)O—, and —CH₂C(CH₃)₂O—. In some embodiments, each OR¹⁰ independently represents —CH₂CH₂O—, —CH(CH₃)CH₂O— or —CH₂CH(CH₃)O—. Each a′ is independently a value from 5 to 300 (in some embodiments, from 10 to about 250, or from 20 to about 200).

In some embodiments, the condensation-curable polyorganosiloxane in the second composition comprises a terminal unit represented by formula -Q-Si(Y)ₚ(R)₃₋ₚ, wherein Q, R, and p are as defined above in any of their embodiments. For terminal -Q-Si(Y)ₚ(R)₃₋ₚ groups, Q may also be a bond. In some embodiments, the condensation-curable polysiloxane includes one terminal unit represented by formula -Q-Si(Y)ₚ(R)₃₋ₚ. In some embodiments, the condensation-curable polysiloxane includes two terminal units represented by formula -Q-Si(Y)ₚ(R)₃₋ₚ. If the polysiloxane is branched, it can include more than two terminal units represented by formula -Q-Si(Y)ₚ(R)₃₋ₚ. In some embodiments, the polysiloxane includes at least one terminal unit represented by formula -Q-Si(Y)ₚ(R)₃₋ₚ.

In some embodiments, the condensation-curable polyorganosiloxane in the second composition is represented by formula XII.

(R′)R₂SiO[R₂SiO]ᵣ[((Y)ₚ(R)₃₋ₚ SiQ)(R)SiO)]ₛSiR₂(R′) XII

In formula XII, each R′ is independently R or a terminal unit represented by formula -Q-Si(Y)ₚ(R)₃₋ₚ; R, Y, Q, and p are as defined above in any of their embodiments, s is at least 1, and r+s is in a range from 10 to 1000, 10 to 500, 10 to 400, 10 to 300, 12 to 300, 13 to 300, 13 to 200, 10 to 100, 10 to 50, or 10 to 30. In some embodiments when s is 1, each R′ is independently represented by formula -Q-Si(Y)ₚ(R)₃₋ₚ. In some embodiments of formula XII, at least 40 percent, and in some embodiments at least 50 percent, of the R groups are phenyl, methyl, or combinations thereof. For example, at least 60 percent, at least 70 percent, at least 80 percent, at least 90 percent, at least 95 percent, at least 98 percent, or at least 99 percent of the R groups can be phenyl, methyl, or combinations thereof. In some embodiments of formula XII, at least 40 percent, and in some embodiments at least 50 percent, of the R groups are methyl. For example, at least 60 percent, at least 70 percent, at least 80 percent, at least 90 percent, at least 95 percent, at least 98 percent, or at least 99 percent of the R groups can be methyl. In some embodiments, each R is methyl. Although formula XII is shown as a block copolymer, it should be understood that the divalent units of formulas X and XI can be randomly positioned in the copolymer. Thus, polyorganosiloxanes useful for practicing the present disclosure also include random copolymers.

In some embodiments, the ratio of r units to s units and R′ groups represented by -Q-Si(Y)ₚ(R)₃₋ₚ or Y is at least 4, 5, 10 and up to 400, 300, 200, 100, or 75.

In some embodiments, the condensation-curable polyorganosiloxane in the second composition includes at least one divalent unit represented by formula XV

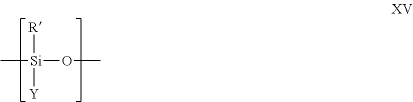

wherein Y is as defined above in any of its embodiments, and R′ is R or Y. In some embodiments, the condensation-curable polyorganosiloxane has at least one —Si(R′)₂(Y) end group, where R′ is R or Y, and Y is as defined above in any of its embodiments. In some embodiments, each Y is independently alkoxy, aryloxy, or acyloxy. In some embodiments, each Y is independently alkoxy having up to ten carbon atoms. In some of these embodiments, each Y is independently alkoxy having from 1 to 6 (e.g., 1 to 4) carbon atoms. In some of these embodiments, each Y is independently methoxy or ethoxy. In some embodiments, each R′ is independently phenyl or methyl. In some embodiments, each R′ is methyl.

While some units represented by formula XV may be present and while the condensation-curable polyorganosiloxane may be branched in some embodiments, the condensation-curable polyorganosiloxane is not considered a silsesquioxane. In some embodiments, the condensation-curable polyorganosiloxane has less than 10 percent, less than 5 percent, less than 2.5 percent, or less than 1 percent by weight units represented by formula RSiO3/2, based on the total weight of the condensation-curable polyorganosiloxane.

In some embodiments of the condensation-curable polyorganosiloxane in the second composition, each Y is methoxy. In some embodiments, the weight percent of methoxy groups in the condensation-curable polyorganosiloxane is not more than 25%, 20%, 15%, 10%, or 5%, based on the total weight of the polyorangosiloxane. In some embodiments, the weight percent of methoxy groups in the condensation-curable polyorganosiloxane is at least 0.05%, 0.1%, 0.5%, 1.0%, or 1.5%, based on the total weight of the polyorangosiloxane.

In some embodiments, the second composition includes at least 1 weight percent (wt. %), at least 5 wt. %, at least 10 wt. %, at least 50 wt. %, or at least 60 wt. % of the condensation-curable polyorganosiloxane, based on the total weight of the second composition. In some embodiments, the composition includes up to 99 wt. %, up to 95 wt. %, or up to 90 wt. % of the condensation-curable polyorganosiloxane, based on the total weight of the second composition. In embodiments that include solvent and/or water, any of these percentages can be based on the total weight of the solids in the second composition (that is, excluding solvent and/or water).

Condensation-curable polysiloxanes can be prepared by known synthetic methods, and many are commercially available (for example, from Wacker Chemie AG, Munich, Germany, Shin-Etsu Chemical, Tokyo, Japan, Dow Corning Corporation, or from Gelest, Inc. (see, for example, the polysiloxanes described in Silicon Compounds: Silanes and Silicones, Second Edition, edited by B. Arkles and G. Larson, Gelest, Inc. (2008))). Polyorganosiloxanes can be prepared by using known synthetic methods including the platinum-catalyzed addition reaction of an olefin (e.g., vinyltrimethoxysilane) and a hydrosiloxane (small molecule, oligomer, or polymer).

In some embodiments, the condensation-curable polyorganosiloxane in the composition of the present disclosure has a number average molecular weight of at least 300 grams per mole, at least 500 grams per mole, at least 1000 grams per mole, at least 2000 grams per mole, at least 3000 grams per mole, at least 4000 grams per mole, or at least 5000 grams per mole. Polysiloxanes disclosed herein typically have a distribution of molecular weights. The number and type of repeating units, end groups, and the molecular weights of polysiloxanes can be determined, for example, by nuclear magnetic resonance (NMR) spectroscopy (including ²⁹Si NMR spectroscopy) using techniques known to one of skill in the art. The number of —Si(Y)ₚ(R)₃₋ₚ groups in a polyorganosiloxane can be determined by NMR.

Molecular weights, particularly for higher molecular-weight materials, including number average molecular weights and weight average molecular weights, can also be measured, for example, by gel permeation chromatography (i.e., size exclusion chromatography) using techniques known to one of skill in the art.

In some embodiments, the second composition includes an amino-functional silane represented by formula XX:

(R⁶)₂N—[R⁴—Z]ᵣ—R⁴—[Si(Y)ₚ(R⁵)₃₋ₚ] (XX)

In formula XX, each R⁴ is independently alkylene, arylene, or alkylene interrupted or terminated by arylene. In some embodiments, each R⁴ is independently a divalent alkylene group. In some embodiments, each R⁴ is independently a divalent alkylene group having up to 6 (in some embodiments, 5, 4, or 3) carbon atoms. Each Z is independently —O— or —NR⁶—, and r is 0, 1, 2, or 3. In some embodiments, r is 0. In some embodiments, each Z is —NR⁶—. In some embodiments, r is 1, 2, or 3. In some embodiments, r is 1 or 2. In embodiments in which r is 1, 2, or 3, the second amino-functional silane includes diamino-functional silanes, triamino-functional silanes, and tetraamino-functional silanes, for example. In some embodiments in which r is greater than 0, —[R⁴—Z]ᵣ—R⁴— is represented by formula —CH₂—CH₂—N(R⁶)—CH₂—CH₂—CH₂— or —CH₂—CH₂—N(R⁶)—CH₂—CH₂—N(R⁶)—CH₂—CH₂—CH₂—.

In formula XX, each R⁵ can independently be alkyl, aryl, or alkylenyl interrupted or terminated by aryl. In some embodiments, R⁵ is alkyl or arylalkylenyl. In some of these embodiments, R⁵ is alkyl (e.g., methyl or ethyl).

In formula XX, each R⁶ is independently hydrogen, alkyl, aryl, alkylenyl interrupted or terminated by aryl, or —R⁴—[Si(Y)ₚ(R⁵)₃₋ₚ], where R⁴ is defined as in any of the above embodiments. In some embodiments, one R⁶ group is hydrogen or alkyl, and the other R⁶ group is —R⁴—[Si(Y)ₚ(R⁵)₃₋ₚ]. In some of these embodiments, one R⁶ group is alkyl, and the other R⁶ group is —R⁴—[Si(Y)ₚ(R⁵)₃₋ₚ]. In some of these embodiments, alkyl may have up to 6 (in some embodiments, up to 5, 4, 3, or 2) carbon atoms. In some embodiments, one R⁶ group is hydrogen or methyl, and the other R⁶ group is —R⁴—[Si(Y)ₚ(R⁵)₃₋ₚ]. In some of these embodiments, one R⁶ group is hydrogen, and the other R⁶ group is —R⁴—[Si(Y)ₚ(R⁵)₃₋ₚ]. In some embodiments, each R⁶ is hydrogen. In some embodiments, at least one R⁶ is alkyl having up to 6 (in some embodiments, up to 5, 4, 3, or 2) carbon atoms. In some embodiments, one R⁶ is methyl and one R⁶ is hydrogen.

In formula XX, Y and p are independently defined as above for condensation-curable polysiloxanes having —Si(Y)ₚ(R)₃₋ₚ groups, in any of their embodiments.

Examples of amino-functional silanes suitable for the composition of the present disclosure include 3-aminopropyltrimethoxysilane, 3-aminopropyltriethoxysilane, bis(3-trimethoxysilylpropyl)amine, bis(3-triethoxysilylpropyl)amine, N-methyl-bis(3-trimethoxysilylpropyl)amine, N-methyl-bis(3-triethoxysilylpropyl)amine, [3-(2-aminoethylamino)propyl]trimethoxysilane, 3-[2-(2-aminoethylamino)ethylamino]propyltrimethoxysilane, [3-(2-aminoethylamino)propyl]triethoxysilane, 3-[2-(2-aminoethylamino)ethylamino]propyltriethoxysilane, N,N′-bis[3-trimethoxysilylpropyl]-ethylenediamine, N,N-bis[3-trimethoxysilylpropyl]-ethylenediamine, and combinations thereof.

In some embodiments, the second composition includes a cyclic azasilane. Such compounds may be represented by the following formula XXIII.

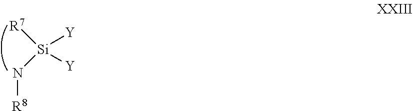

In formula XXIII, R⁷ is an alkylene having 2 to 5 carbon atoms and is uninterrupted or interrupted by at least one catenated —N(R⁸)—, wherein each R⁸ is independently hydrogen, alkyl, or alkenyl, in some embodiments, having up to 12, 6, 4, 3, or 2 carbon atoms and unsubstituted or substituted by —N(R⁶)₂, wherein is R is independently as defined above; and each Y is independently as defined above in any of its embodiments in connection with formula X. Examples of suitable cyclic azasilanes include 2,2-dimethoxy-N-butyl-1-aza-2-silacyclopentane, 2-methyl-2-methoxy-N-(2-aminoethyl)-1-aza-2-silacyclopentane, 2,2-diethoxy-N-(2-aminoethyl)-1-aza-2-silacyclopentane, 2,2-dimethyl-N-allyl-1-aza-2-silacyclopentane, 2,2-dimethoxy-N-methyl-1-aza-2-silacyclopentane, 2,2-diethoxy-1-aza-2-silacyclopentane, 2,2-dimethoxy-1,6-diaza-2-silacyclooctane, and N-methyl-1-aza-2,2,4-trimethylsilacyclopentane.

The second composition includes at least one of an amino-functional silane of formula XX or cyclic azasilane of formula XXIII. In some embodiments, the second composition includes the amino-functional silane. In some embodiments, the second composition includes the cyclic azasilane. In some embodiments, the second composition includes both the amino-functional silane and the cyclic azasilane.

In some embodiments, the second composition of the present disclosure includes at least 1 wt. %, at least 0.1 wt. %, at least 0.01 wt. %, or at least 0.001 wt. % of at least one of the amino-functional silane or cyclic azasilane, including any of those described above, based on the total weight of the second composition. In some embodiments, the second composition includes up to 10 wt. %, up to 5 wt. %, or up to 1 wt. % of at least one of the amino-functional silane or cyclic azasilane, including any of those described above, based on the total weight of the second composition. In embodiments that include solvent and/or water, any of these percentages can be based on the total weight of the solids in the composition (that is, excluding solvent and/or water).

The second composition can include polyorganosiloxanes other than the condensation-curable polyorganosiloxane described above. Other polyorganosiloxanes in the composition may or may not include reactive functional groups (e.g., hydrolyzable, vinyl, mercapto, amino, hydroxyl, or hydride functional groups).

In some embodiments, the second composition includes a second polyorganosiloxane comprising divalent units represented by formula: formula X:

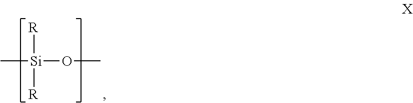

wherein each R is independently as defined above in any of its embodiments, wherein the second polyorganosiloxane does not include hydrolyzable groups. The second polyorganosiloxane may be a linear polyorganosiloxane consisting of divalent units represented by formula X and terminal —Si(R)₃ groups, wherein each R is independently as defined above in any of its embodiments. In some embodiments, each R is methyl. In some embodiments, the second polyorganosiloxane is a polydimethylsiloxane having no reactive functional groups.

However, as described above, the second composition can include a mixture of polyorganosiloxanes comprising divalent units represented by formula: formula X:

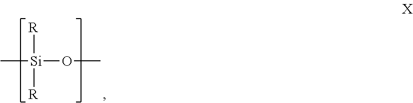

wherein each R is independently as defined above in any of its embodiments, wherein the polyorganosiloxane have different numbers of —Si(Y)ₚ(R)₃₋ₚ groups, wherein Y is hydroxyl or a hydrolyzable group, R is as defined above in any of its embodiments, and p is 1, 2, or 3 (in some embodiments, 2 or 3, or 3). Suitable hydrolyzable groups include any of those described above for the condensation-curable polyorganosiloxane. In some embodiments, each Y is independently alkoxy, aryloxy, or acyloxy. In some embodiments, each Y is independently alkoxy having up to ten carbon atoms. In some of these embodiments, each Y is independently alkoxy having from 1 to 6 (e.g., 1 to 4) carbon atoms. In some of these embodiments, each Y is independently methoxy or ethoxy. Mixtures of polyorganosiloxanes having different numbers of —Si(Y)ₚ(R)₃₋ₚ groups can be combined in ratios such that the condensation-curable polyorganosiloxane composition overall has an average of greater than two —Si(Y)ₚ(R)₃₋ₚ groups, for example.

A wide variety of molecular weights may be suitable for the second or mixtures of polyorganosiloxanes useful for the second composition, depending upon, for example, the properties desired for the second composition. In some embodiments, second or further polyorganosiloxanes useful for practicing the present disclosure have a weight average molecular weight of 100 grams per mole to 100,000 grams per mole.

If the second composition includes at least one of the second or mixtures of polyorganosiloxane, in some embodiments, the second composition includes at least 0.01 wt. %, at least 0.1 wt. %, or at least 1 wt. % of at least one of the second or further polyorganosiloxane, including any of those described above, based on the total weight of the composition. In some embodiments, the second composition includes up to 10 wt. %, up to 5 wt. %, or up to 1 wt. % of at least one of the second or further polyorganosiloxane, including any of those described above, based on the total weight of the second composition. In embodiments that include solvent and/or water, any of these percentages can be based on the total weight of the solids in the composition (i.e., excluding solvent and/or water).

In some embodiments, the second composition includes a catalyst, for example, for the hydrolysis of the hydrolyzable groups in the condensation-curable polyorganosiloxane, amino-functional silane, cyclic azasilane, and optionally mixture of polyorganosiloxanes. In some embodiments, the catalyst is an acid. Suitable acid catalysts include acetic acid, chloroacetic acid, dichloroacetic acid, trichloroacetic acid, trifluoroacetic acid, citric acid, formic acid, triflic acid, perfluorobutylsulfonic acid, dinonylnaphthalene sulfonic acid, dinonylnaphthalene disulfonic acid, perfluorobutyric acid, p-toluenesulfonic acid, dodecylsulfonic acid, dodecylbenzenesulfonic acid, benzenesulfonic acid, methanesulfonic acid, sulfuric acid, hydrochloric acid, phosphoric acid, and nitric acid. The catalyst can also be a Lewis acid, such as boron compounds such as boron trifluoride, boron tribromide, triphenylborane, triethylborane, and tris(pentafluorophenyl)borane. In some embodiments the catalyst is a base. Examples of useful base catalysts include alkali metal hydroxides, tetraalkylammonium hydroxides, ammonia, hydoxylamine, imidazole, pyridine, N-methylimidazole, diethylhydroxylamine, morpholine, N-methyl morpholine, and other amine compounds. In some embodiment, the catalyst is a strong neutral organic base such as an amidine, guanidine, phosphazene, or proazaphosphatrane, as described in U.S. Pat. No. 9,175,188 B2 (Buckanin et. al). In some embodiments, the catalyst is an organometallic compound. Suitable catalysts include alkoxides, carboxylates, acetyl acetonates, and other chelates of Sn, Al, Bi, Pb, Zn, Ca, V, Fe, Ti, K, Ba, Mn, Ni, Co, Ce, and Zr, for example. Some examples include dibutyl tin dilaurate, dibutyl tin diacetate, dibutyl tin dichloride, dibutyl tin dibromide, dibutyl tin bis(acetylacetonate), dibutyl tin dioxide, dibutyl tin dioctoate, tin (II) octoate, tin (II) neodecanoate, tetraisopropoxy titanium, tetra-n-butoxytitanium, titanium tetrakis(2-ethylhexoxy), triethanolamine titanate chelate, titanium diisopropoxide (bis-2,4-pentanedionate), aluminum tris(acetylacetonate), aluminum titanate, zinc ethylhexanoate, aluminum tris(ethylacetoacetate), diisopropocyaluminum ethyl acetoacetate; bismuth tris(2-ethylhexonate), bismuth tris(neodecanoate); zirconium tetra-acetylacetonate and titanium tetra-acetylactonate, lead octylate, and K-Kat 670 (King Industries, Norwalk CT).

If the second composition includes a catalyst, in some embodiments, the second composition of the present disclosure includes at least 0.1 wt. %, at least 0.01 wt. %, or at least 0.001 wt. % of a catalyst, including any of those described above, based on the total weight of the second composition. In some embodiments, the second composition includes up to 5 wt. %, up to 2.5 wt. %, or up to 1 wt. % of a catalyst, including any of those described above, based on the total weight of the second composition. In embodiments that include solvent and/or water, any of these percentages can be based on the total weight of the solids in the composition (i.e., excluding solvent and/or water).

In some embodiments, the second composition of the present disclosure includes at least one additional silane having hydrolyzable functionality. The silane can be useful, for example, as a crosslinker and/or diluent. In some embodiments, the second composition of the present disclosure includes a mixture of silanes having hydrolyzable functionality.

In some embodiments, the silane is represented by formula XXV.

R^{3′}_{f′}[Si(Y)_{4-f′}]_{g′} XXV

wherein g′ is 1 to 6, f′ is 0, 1, or 2, with the proviso that when f′ is 0, g is 1; each R^{3′} is monovalent or multivalent, and is independently alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each unsubstituted or substituted with at least one epoxy, thiol (i.e., —SH), (meth)acrylate, vinyl (i.e., —CH═CH₂), allyl (i.e., H₂C═CH—CH₂—), isocyanate (i.e., —N═C═O), thiocyanate (i.e., —S═C═N), ureido (e.g., —NH—C(O)—NH₂), chloro (i.e., —Cl), or a combination thereof; and each Y is a hydrolysable group. R¹¹ is hydrogen, alkyl, aryl, or arylalkylenyl, wherein aryl and arylalkylenyl are unsubstituted or substituted by at least one alkyl, alkoxy, or combination thereof. In some embodiments, R¹¹ is hydrogen or alkyl, for example, having 1 to 4 carbon atoms (e.g., methyl, ethyl, n-propyl, isopropyl, n-butyl, isobutyl, or sec-butyl). In some embodiments, R¹¹ is methyl or hydrogen.

In formula XXV, suitable Y groups include hydroxyl and any of the hydrolysable groups described above for polysiloxanes having —Si(Y)ₚ(R)₃₋ₚ groups, in any of their embodiments.

In formula XXV, R^{3′} can include a straight chain, branched, or cyclic group, or a combination thereof. In some embodiments, each R^{3′} independently includes 1 to 18, 1 to 12, 1 to 8, 1 to 6, or 2 to 6 carbon atoms. In some embodiments, each R^{3′} is independently alkyl having 1 to 18, 1 to 12, 1 to 6, or 2 to 6 carbon atoms. In some embodiments, each R^{3′} includes at least one catenated oxygen atom. In some embodiments, each R^{3′} is independently alkyl having at least one catenated oxygen atom. In some embodiments, each R^{3′} includes at least one epoxy, thiol, (meth)acrylate, vinyl, allyl, isocyanate, thiocyanate, ureido, or chloro group or a combination thereof.

In some embodiments of formula XXV, g′ is 1 or 2. In some embodiments, g′ is 1.

In some embodiments of formula XXV, f is 1.

Useful silanes represented by formula XXV include methacryloxypropyltrimethoxysilane, 3-glycidoxypropyltrimethoxysilane, isooctyltrimethoxysilane, 3-mercaptopropyltrimethoxysilane, isobutyltrimethoxysilane, and tetraethyl orthosilicate.

In some embodiments, the silane in the second composition is represented by formula XXVI.

L-R^{3b′}—Si(Y)_{3-f′}(R^{3a′})_{f′} XXVI

In formula XXVI, Y is hydroxyl or a hydrolyzable group as defined above in any of its embodiments described in connection with polysiloxanes having —Si(Y)ₚ(R)₃₋ₚ groups. R^{3a′} is monovalent alkyl, aryl, arylalkylenyl, wherein alkyl and arylalkylenyl are each uninterrupted or interrupted with at least one catenated —O—, —N(R¹¹)—, —S—, —P—, —Si— or combination thereof, and wherein aryl and arylalkylenyl are each unsubstituted or substituted by alkyl or alkoxy. R^{3b} is divalent alkylene, arylene, or arylalkylene, wherein alkylene and arylalkylene are each uninterrupted or interrupted with at least one catenated —O—, —N(R¹¹)—, —S—, —P—, —Si— or combination thereof, and wherein arylene and arylalkylene are each unsubstituted or substituted by alkyl or alkoxy. R¹¹ is as defined above in connection with formula XXV in any of its embodiments. L is epoxy, thiol, (meth)acrylate, vinyl, allyl, isocyanate, thiocyanate, ureido, or chloro. In formula f′ is 0 or 1. In some embodiments, f′ is 0. In some embodiments, R^{3b′} is alkylene having 1 to 18, 1 to 12, 1 to 8, 1 to 6, or 2 to 6 carbon atoms and is uninterrupted or interrupted with at least one catenated —O— or —N(R¹¹)— or combination thereof. In some embodiments, R^{3b′} is alkylene having 2 to 6 carbon atoms.

In some embodiments, the silane in the second composition can be partially hydrolyzed and condensed. Such compounds may be represented by formula XXVII.

Y—[Si(R^{3c′})(Y)—O]_{r″}—Si(R^{3c′})(Y)₂ XXVII

In formula XXVII, r″ is 1 to 20, Y is hydroxyl or a hydrolyzable group as defined above in any of its embodiments described in connection with polysiloxanes having —Si(Y)ₚ(R)₃₋ₚ groups, and each R^{3c′} is independently monovalent alkyl, aryl, arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each unsubstituted or substituted with at least one epoxy, thiol, (meth)acrylate, vinyl, allyl, isocyanate, thiocyanate, ureido, chloro, or a combination thereof. R¹¹ is as defined above in connection with formula XXV in any of its embodiments. In some embodiments, each R^{3c′} is independently alkylene having 1 to 18, 1 to 12, 1 to 6, or 2 to 6 carbon atoms and is uninterrupted or interrupted with at least one catenated —O— or —N(H)— or combination thereof. In some embodiments, each R^{3c′} is independently alkylene having 2 to 6 carbon atoms.

In some embodiments, the second composition includes at least 0.01 wt. %, at least 0.1 wt. %, or at least 1 wt. % of the at least one additional silane having hydrolyzable functionality, including any of those described above, based on the total weight of the composition. In some embodiments, the composition includes up to 30 wt. %, up to 25 wt. %, or up to 15 wt. % of at least one additional silane having hydrolyzable functionality, including any of those described above, based on the total weight of the composition. In embodiments that include solvent and/or water, any of these percentages can be based on the total weight of the solids in the composition (i.e., excluding solvent and/or water).

In some embodiments of the second composition, the second composition includes a solvent (e.g., an organic solvent). Suitable organic solvents can be selected to provide a second composition that has good spreading characteristics, that can be easily applied to a surface, that does not evaporate too quickly or too slowly, and that permits excess composition to be removed without creating streaks that impair the appearance of the finished, coated surface, that solubilize other components of the composition but does not solubilize components of the underlying coatings (e.g., paint, plastic, glass). Combinations of organic solvents may be used to impart desired properties to the second composition.

In some embodiments, the second composition includes a cyclosiloxane solvent or other methylated siloxane solvent. Examples of useful siloxane solvents include hexamethyldisiloxane, octamethyltrisiloxane, decamethyltetrasiloxane, dodecamethylpentasiloxane, tetradecamethylhexasiloxane, hexadecamethylheptasiloxane, methyltris(trimethylsiloxy)silane, octamethylcyclotetrasiloxane, decamethylcyclopentasiloxane, and dodecamethylcyclohexasiloxane. In some embodiments, the second composition includes a cyclosiloxane solvent (such as those commercially available under the trade name “PMX” from Dow Chemical Co., Midland, MI, or Univar, Downers Grove, IL, such as PMX-245 (cyclopentasiloxane) and PMX-246 (cyclohexasiloxane)

Suitable solvents for use in the second composition include aprotic solvents such as isoparaffins (e.g., oil-like, fully-saturated, linear and/or branched aliphatic hydrocarbons having around 9 to 13 carbon atoms, such as those commercially available under the trade name “ISOPAR” from ExxonMobil Chemical Co., Houston, TX, especially ISOPAR L, ISOPAR H, ISOPAR K, ISOPAR M, and ISOPAR N); aromatic fluids (e.g., those produced from petroleum-based raw materials and have an aromatic content of 99% or greater and are composed primarily of C9-C10 dialkyl and trialkylbenzenes, such as those commercially available under the trade name “SOLVESSO” from Brenntag Solvents, Warington, UK, especially Aromatic 100 and Aromatic 200); dearomatized fluids (e.g., aliphatic solvents that include a low amount of aromatic hydrocarbon solvents, in which the major components include normal alkanes, isoalkanes, and cyclics, such as those commercially available under the trade name “EXXSOL” from ExxonMobil Chemical Co., Houston, TX, especially EXXSOL D40, EXXSOL D130, EXXSOL D95, and EXXSOL Methylpentane Naphtha, as well as under the trade name “DRAKESOL” from Calumet Specialty Products Partners, LP, Indianapolis, IN, especially DRAKESOL 205); non-dearomatized fluids (e.g., petroleum hydrocarbon distillates, such as those commercially available under the trade name “VARSOL” from ExxonMobil Chemical Co., Houston, TX, especially VARSOL 1, VARSOL 18, VARSOL 60, and VARSOL 110); paraffins (e.g., refined petroleum solvents including predominantly C7-C11 hydrocarbons, typically 55% paraffins, 30% monocycloparaffins, 2% dicycloparaffins, and 12% alkylbenzenes, such as VM&P Naptha commercially available from Sunnyside Corp., Wheeling, IL, Startex Chemicals, Woodlands, TX, or Spectrum Chemical, New Brunswick, NJ); glycol ethers or esters (e.g., solvents based on alkyl ethers and diethers of ethylene glycol or propylene glycol, such as those commercially available under the trade names “DOWANOL” and “PROGLYDE” from Dow Chemical Co., Midland, MI, or Lyondell Basell, Houston, TX, especially DOWANOL Eph (ethylene glycol phenyl ether), DOWANOL PGDA (propylene glycol diacetate), DOWANOL DPM (di(propylene glycol) methyl ether), DOWANOL DPMA (di(propylene glycol) methyl ether acetate), DOWANOL LoV 485 Coalescent glycol ether, and PROGLYDE DMM (dipropylene glycol dimethyl ether), as well as the ester Butyl Carbitol Acetate (diethylene glycol n-butyl ether acetate)); esters (e.g., isoamyl acetate (3-methylbutyl acetate) and ethyl benzoate); ketones (e.g., diisobutylketone, isobutylheptylketone, and isophorone (an α,β-unsaturated cyclic ketone)); amides (e.g., dimethylformamide); cyclosiloxanes (such as those commercially available under the trade name “PMX” from Dow Chemical Co., Midland, MI, or Univar, Downers Grove, IL, such as PMX-245 (cyclopentasiloxane) and PMX-246 (cyclohexasiloxane); and monoterpenes (e.g., d-limonene and pinene).

In some embodiments, the organic solvent is a non-halogenated organic solvent having a boiling point of at least 160° C. Non-halogenated organic solvents include organic solvents that do not include halogen atoms (e.g., chlorine, bromine), such as halogenated solvents like 1,2-dichlorobenzene.

In some embodiments, the second composition has a volatile organic content (VOC) of no more than 750 grams per liter (g/L) (or no more than 500 g/L, or no more than 250 g/L). In this context, the terms “volatile organic content” and “VOC” refer to the volatility of the composition as measured by ASTM D6886-18 (Standard Test Method for Determination of the Weight Percent Individual Volatile Organic Compounds in Waterborne Air-Dry Coatings by Gas Chromatography). This test uses methyl palmitate as a reference marker. A compound that elutes prior to the marker is considered VOC while a compound that elutes after the marker is not considered VOC. A “non-VOC” compound refers to a compound that elutes after the methyl palmitate marker.

The amount of solvent, if present, should be sufficient to prevent the second composition from evaporating too quickly during application, which may cause the composition to have a streaky appearance or otherwise make it difficult to wipe off any excess composition. Too much solvent may evaporate too slowly or making the composition difficult to apply. In some embodiments of the second composition of the present disclosure, the second composition includes at least 1 wt. %, at least 5 wt. %, or at least 10 wt. % of at least one organic solvent and/or siloxane solvent, based on the total weight of the second composition. In some embodiments, the second composition includes up to 99 wt. %, up to 95 wt. %, or up to 90 wt. % of at least one organic solvent and/or siloxane solvent, based on the total weight of the second composition. In some embodiments, the second composition includes not more than 25 wt. %, 20 wt. %, 15 wt. %, 10 wt. %, 5 wt. %, 4 wt. %, or 1 wt. %, organic solvent and/or siloxane solvent, based on the total weight of the second composition. The organic and siloxane solvents can be any of those described above in any of their embodiments.

The second composition of the present disclosure can include other components to impart particular desired properties. The second composition can include conventional additives such as initiators, emulsifiers (including surfactants), stabilizers, anti-oxidants, flame retardants, adhesion promoters (for example, alkoxysilanes), release modifiers (for example, silicate resins including silicate MQ resin), colorants, thickeners (for example, carboxy methyl cellulose (CMC), polyvinylacrylamide, polypropylene oxide, polyethylene oxide/polypropylene oxide copolymers, polyalkenols), and combinations thereof. In some embodiments, the second composition is substantially free of surfactant (that is, it has less than 1, 0.5, 0.1, or 0.05% by weight surfactant, based on the total weight of the composition.) In some embodiments, second compositions according to the present disclosure comprise water.

In some embodiments, the water is present in the second composition in a range from 0.01 percent to 5 percent (in some embodiments, 0.05 to 1, 0.05 to 0.5, or 0.1 to 0.5 percent) by weight, based on the total weight of the composition. Water may be added to the second composition or may be added as part of an aqueous acidic solution (e.g., concentrated hydrochloric acid is 37% by weight of the acid in water). However, we have found that it is typically not necessary to add water to the compositions described herein. The water useful for hydrolysis of the silane groups may be adventitious water in the solvent or adsorbed to the surface of the substrate or may be present in the atmosphere to which the amino-functional compound and the polyorganosiloxane are exposed (e.g., an atmosphere having a relative humidity of at least 10%, 20%, 30%, 40%, or even at least 50%). The low amount of water can be beneficial to the shelf-stability of some embodiments of the second composition of the present disclosure.

In some embodiments, the second composition can be an emulsion (e.g., an oil-in-water emulsion). In these embodiments, the second composition can include up to 99 wt. %, up to 95 wt. %, or up to 90 wt. % water, based on the total weight of the second composition. In some of these embodiments, the second composition includes at least 50 wt. %, at least 60 wt. %, or at least 75 wt. % water, based on the total weight of the second composition. Purified or deionized water may be useful.

Emulsions typically include an emulsifier. A wide variety of surfactants can be useful as emulsifiers. In some embodiments, the emulsifier includes at least one of a nonionic surfactant or an anionic surfactant. In some embodiments, the emulsifier includes a nonionic surfactant and optionally an anionic surfactant. Suitable nonionic surfactants include polyoxyethylene (POE) and polyoxypropylene (POP) aliphatic ethers having a linear or branched chain with 12 to 20 carbon atoms. The surfactant may include both POE and POP units in a random or block form. The surfactant may contain 1 to 100, 3 to 50, or 5 to 20 POE or POP units or a combination thereof. Suitable examples include POE (4 to 11) lauryl ether, POE (10 to 20) cetyl ether, POE (4 to 20) oleyl ether, POP (5) lauryl ether, POP (7) cetyl ether, POP (10) oleyl ether, and POE (3) POP (5) lauryl ether, wherein the numerical values in parentheses of POE and POP indicate the number of units of oxyethylene unit and oxypropylene unit. In some embodiments, the nonionic surfactant is an alcohol ethoxylate. Examples of suitable anionic surfactants include sulfates of polyethoxylated derivatives of straight or branched chain aliphatic alcohols and carboxylic acids. The anionic surfactant can be the sulfate of any of the polyethoxylated derivatives of straight or branched chain aliphatic alcohols described above. Suitable surfactants are available from a variety of commercial sources. In some embodiments, the surfactant comprises at least one of a five-mole ethoxylate of a linear, primary 12-14 carbon number alcohol available, for example, from Huntsman Corporation, The Woodlands, Tex., under the trade designation “SURFONIC L24-5” Surfactant, an alcohol ethoxylate available, for example, from Dow Chemical Company under the trade designation “ECOSURF EH-6”, and a sodium salt of a fatty alcohol polyglycol ether sulphate, available, for example, from BASF Corporation, Florham Park, N.J., under the trade designation “DISPONIL FES 32IS”.

In some embodiments, the emulsion composition can include up to 10 wt. % or up to 8 wt. % of a surfactant, including any of those described above, based on the total weight of the emulsion. In some embodiments, the emulsion composition includes at least 0.50 wt. % or at least 1 wt. % of a surfactant, including any of those described above, based on the total weight of the emulsion. In some embodiments, the emulsion composition can include up to 10 wt. % or up to 8 wt. % of reactive ingredients, including the condensation-curable polyorganosiloxane, the amino-functional silane or cyclic azasilane, the silane having at least one hydrolyzable group, the second or further polyorganosiloxane, and the catalyst as described above in any of their embodiments, based on the total weight of the emulsion. In some embodiments, the emulsion composition includes at least 1 wt. %, at least 3 wt. %, or about 5 wt. % of these reactive ingredients as described above in any of their embodiments, based on the total weight of the emulsion.

The second composition of the present disclosure can be free of fluorinated silanes, for example, having a structure represented by formula RF-Q-Si(Y)ₚ(R)₃₋ₚ or (Y)ₚ(R)₃₋ₚ Si-Q-RF-Q-Si(Y)ₚ(R)₃₋ₚ, wherein RF is a monovalent or divalent fluoroalkyl group or a perfluoropolyether group, and Q, Y, R, and p are as defined above in any of their embodiments. In some embodiments, the second composition is substantially free of these fluorinated silanes (that is, it has less than 1, 0.5, 0.1, or 0.05% by weight fluorinated silane, based on the total weight of the second composition, excluding solvent and/or water.

The second composition can be prepared by combining the various components, in some embodiments, with agitation or stirring. The second composition can be maintained as a relatively shelf-stable, two-part system (for example, by keeping the catalyst separate from the condensation-curable polyorganosiloxane and other silane compounds), if desired, but a one-part system (comprising the catalyst, condensation-curable polyorganosiloxane, amino-functional silane, cyclic azasilane, and optionally other silanes and siloxanes) can also be stable (such that there is no gelling or precipitation, for example) for periods of at least two months, and often up to one year, or five years, or even longer if packaged to exclude moisture before coating or otherwise applying the second composition. When the second composition is an emulsion, its shelf life can be maximized by storing it sealed at room temperature in a container with minimal headspace and avoiding exposing it to ambient air. The container can be purged with inert gas before filling. Utilization of a ventless sprayer to apply the composition may also be useful.

A variety of methods may be useful for applying the first composition and the second composition. Typically, and advantageously, a small amount of first composition followed by a small amount of the second composition can be applied to the surface to be treated. For example, approximately 6 drops/ft² (65 drops/m²) may be used, depending on the condition of the surface being treated (weathered or deteriorated surfaces may benefit from using a larger amount of the first and/or second composition). The first composition and second composition may be applied to a surface either directly using a variety of techniques (e.g., spraying), or the first composition may be first applied to a spreading device (e.g., a cloth) and then applied to a surface. This can then be repeated with the second composition. In one convenient approach, the first composition and subsequently the second composition may be evenly distributed on a surface by hand-wiping with a clean, dry cloth or pad (e.g., a suede or microfiber cloth, a foam pad, or a combination thereof) using, for example, overlapping circular strokes. In some embodiments, second composition is applied to at least a portion of the first composition within 30, 15, or 10 minutes after the first composition is applied to the siliceous substrate. This is useful, of example, for preventing contamination of the surface before the second composition is applied.

The kit of the present disclosure includes a container comprising the first composition described above in any of its embodiments and a container comprising the second composition described above in any of its embodiments. The kit can include at least one of a wipe or pad for applying at least one of the first composition or the second composition to the siliceous substrate. The wipe can be any suitable material such as cloth (e.g., a suede or microfiber cloth). The pad can be, for example, a foam pad. In some embodiments, the kit includes a spray applicator.

In some embodiments of the process of making a coated article of the present disclosure, the process comprises allowing or inducing the second composition to at least partially cure. In some embodiments, at least 0.1 minute, at least 1 minute, from two to five minutes, or no more than 30 minutes after the second composition is applied, excess composition may be wiped off and the coating allowed to further cure. In some embodiments, at least 0.1 minute, at least 1 minute, from two to five minutes, or no more than 30 minutes after the second composition is applied, excess composition may be wiped off, and the second composition can be applied again. In some embodiments, the second composition is allowed or induced to cure for 30 seconds to 30 minutes before the excess is wiped off. In some embodiments, cure conditions of 70° F.±5° F. (21.1° C.±2.8° C.) and 50%+3% relative humidity are used. Shorter or longer curing times may be used if desired by the user. The second composition may then be allowed to cure for up to 10 days, 7 days, 3 days, 5 days, one day, or one hour at 70° F.±5° F. (21.1° C.±2.8° C.) and 50%±3% relative humidity. In some embodiments, multiple coats are applied, allowing a three-day cure for each coat.

In some embodiments, the siliceous substrate may be cleaned before the application of the first composition. For example, 3M Glass Polishing Compound “3M 60150” can optionally be used to remove scale and other contaminants before application of the first composition. Other cleaners that may be useful include 3M Glass Cleaner “3M 08888”, 3M Inspection Spray “3M 06082”, and one or more organic solvents such as aliphatic alcohols (e.g., methanol, ethanol, and isopropanol); ketones (e.g., acetone, 2-butanone, and 2-methyl-4-pentanone); esters (e.g., ethyl acetate, butyl acetate, and methyl formate); ethers (e.g., diethyl ether, diisopropyl ether, methyl t-butyl ether, 2-methoxypropanol, and dipropyleneglycol monomethylether (DPM)). Any of these cleaners may be used alone or in combination.

In some embodiments of the process of the present disclosure, the composition provides a clear, streak-free, and in some cases, a glass-like, finish on the siliceous surface. In some embodiments, the first composition and second composition do not change the appearance of the siliceous substrate, which means a change in appearance of the siliceous substrate cannot be detected by the naked eye after application of the first composition and the second composition. In some embodiments, the thickness of the coating after applying the first composition and the second composition is less than 1 micrometer, typically less than 500 nanometers. In some embodiments, the thickness of the treatment is at least about 1, 5, 10, or 20 nanometers, up to about 100, 50, or 20 nanometers. Thin coatings made according to the processes disclosed herein typically and advantageously are transparent and do not change the visual appearance, thermal conductivity, or mechanical properties of the siliceous substrate.

In some embodiments of the coated articles made by the process of the present disclosure, the process provides excellent water-beading on siliceous substrates, encouraging a large number of well-rounded, hemispherical water drops to form or “bead up.” Advantageously, these drops often easily roll off automotive glass, carrying and dirt or debris with them. Thus, processes described herein may promote faster drying and a self-cleaning property of a siliceous surface that subsequently becomes wet.

In some embodiments of the articles made by the process of the present disclosure, the process facilitates the release of water from siliceous substrates. Water applied to such a substrate (for example, from precipitation or rinse water used to wash and clean a substrate surface) will be readily released from or “run off” the surface, thereby reducing the water marks or water spots that may have to be removed once any water that remains on the coated surface evaporates.

Desirably, the process typically provides sufficient durability to maintain acceptable performance and a desired appearance even after the coated surface has been subjected to repeated washing and rinsing cycles. For example, a motor vehicle panel that has been treated according to some embodiments of the present disclosure may still promote excellent water-beading, encouraging a large number of small, well-rounded, hemispherical water drops to form or “bead up” even after more than 100 back-and-forth wiping motions (cycles) with a soft foam pad that has been saturated with water or a 9% aqueous automotive shampoo solution, or more than 200 cycles, or more than 250, 500, or 1000 cycles.

In some embodiments, an article is prepared as described herein using the Glass Plate Treatment with the First Composition Method and Glass Plate Treatment with the Second Composition Method in the Examples Section, in which a first composition is applied and allowed to cure for 30 seconds before excess is removed. Within 15 minutes of removing the excess, the second composition is applied. The second composition is applied twice and each time allowed to cure for two minutes before the excess coating solution is removed, with 60 minutes between coats. The coated plates are then allowed to further cure or dry for at least 72 hours in a controlled temperature and humidity room set at 73° F. (23° C.) and 50% relative humidity. In some embodiments, the articles prepared in this manner display at least one of the following properties: a receding contact angle of greater than 90 degrees measured according to the Water Contact Angle Test Method of the Examples Section or a receding contact angle of greater than 80 degrees after 2000 scrubs (made according to the Coated Glass Plate Scrub Method in the Examples Section) measured according to the Water Contact Angle Test Method in the Examples Section.

Typically, and advantageously, the process provides a receding higher contact angle after 500, 1000, and 2000 scrubs than a process in which only the second composition is applied to the siliceous substrate. The beneficial effect of the first composition is typically not observed when the amino-functional silane or cyclic azasilane is not present in the second composition as shown in Illustrative Examples 3 and 4 below. In some embodiments, the beneficial effect of the first composition is not observed when the second composition does not include a catalyst for at least one of hydrolyzing hydrolyzable groups in at least one of the condensation-curable polyorganosiloxane, amino-functional silane, or cyclic azasilane or condensing silanol groups to form siloxane bonds. In some embodiments, the beneficial effect was not observed when the first composition included an amine-reactive organosilane compound (3-glycidoxypropyl-trimethoxysilane) that was not at least partially hydrolyzed.

In addition, while the various embodiments have particular utility for motor vehicles, other applications are contemplated such as use on siliceous surfaces associated with marine and aerospace environments, household uses (e.g., tub and shower enclosures), and for building maintenance (e.g., windows).

### Some Embodiments of the Disclosure

In a first embodiment, the present disclosure provides a process for making a coated article, the process comprising:
applying a first composition on at least the portion of a siliceous substrate, the first composition comprising an amine-reactive organosilane compound, wherein the amine-reactive organosilane compound is at least partially hydrolyzed; and subsequently
applying a second composition on at least a portion of the first composition, the second coating composition comprising at least one of an amino-functional silane or cyclic azasilane and a condensation-curable polyorganosiloxane having divalent units represented by formula

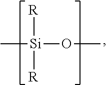

wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In a second embodiment, the present disclosure provides the process of the first embodiment, wherein the siliceous substrate comprises automotive glass.

In a third embodiment, the present disclosure provides the use of a first composition to improve durability of a second composition on a siliceous substrate, wherein the first composition comprises an amine-reactive organosilane compound, wherein the amine-reactive organosilane compound is at least partially hydrolyzed, and wherein the second composition comprises at least one of an amino-functional silane or cyclic azasilane and a condensation-curable polyorganosiloxane having divalent units represented by formula

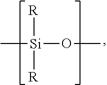

wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In a fourth embodiment, the present disclosure provides the process or use of any one of the first to third embodiments, wherein the first composition and second composition do not change the appearance of the siliceous substrate.

In a fifth embodiment, the present disclosure provides a kit comprising:
a container comprising a first composition comprising an at least partially hydrolyzed amine-reactive organosilane compound; and
a container comprising a second composition comprising at least one of an amino-functional silane or cyclic azasilane and a condensation-curable polyorganosiloxane having divalent units represented by formula

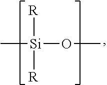

wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In a sixth embodiment, the present disclosure provides the process, use, or kit of any one of the first to fifth embodiments, wherein the condensation-curable polyorganosiloxane in the second coating composition comprises more than one functional group selected from the group consisting of silanol, hydrolyzable silane, or a combination thereof.

In a seventh embodiment, the present disclosure provides the process, use, or kit of any one of the first to sixth embodiments, wherein the second composition further comprises a catalyst for at least one of hydrolyzing hydrolyzable groups in at least one of the condensation-curable polyorganosiloxane, amino-functional silane, or cyclic azasilane or condensing silanol groups to form siloxane bonds.

In an eighth embodiment, the present disclosure provides the process, use, or kit of any one of the first to seventh embodiments, wherein the amine-reactive organosilane compound is represented by formula:

R³_{f}[Si(X)_{4-f}]_{g}

wherein:
g is 1 to 6;
f is 1 or 2;
each R³ is monovalent or multivalent and is independently alkyl, aryl, or arylalkylenyl, wherein alkyl and arylalkylenyl are each uninterrupted or interrupted with at least one catenated —O—, —N(R¹)—, —S—, —P—, —Si— or combination thereof, wherein aryl and arylalkylenyl are each unsubstituted or substituted by alkyl or alkoxy, and wherein at least one R³ is substituted with at least one epoxy, (meth)acrylate, isocyanate, chloro, or a combination thereof, and wherein R¹¹ is hydrogen, alkyl, aryl, or arylalkylenyl, wherein aryl and arylalkylenyl are unsubstituted or substituted by at least one alkyl, alkoxy, or combination thereof, and
X is independently hydroxyl or a hydrolyzable group, with the proviso that at least one X is hydroxyl.

In a ninth embodiment, the present disclosure provides the process, use, or kit of the eighth embodiment, wherein f is 1, and wherein g is 1.

In a tenth embodiment, the present disclosure provides the process, use, or kit of the eighth or ninth embodiment, wherein at least one R³ is substituted with epoxy.

In an eleventh embodiment, the present disclosure provides the process, use, or kit of any one of the eighth to tenth embodiments, wherein each X is hydroxyl or (C₁-C₄)alkoxy.

In a twelfth embodiment, the present disclosure provides the process, use, or kit of any one of the eighth to eleventh embodiments, wherein amine-reaction organosilane comprises 3-glycidoxypropyltrimethoxysilane.

In a thirteenth embodiment, the present disclosure provides the process, use, or kit of any one of the first to seventh embodiments, wherein the at least partially hydrolyzed amine-reactive organosilane compound is represented by formula:

X—[Si(R^{3c})(X)—O]_{r″}—Si(R^{3c})(X)₂

wherein:
r″ is 1 to 20;
each R^{3c} is independently monovalent alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each substituted with at least one epoxy, (meth)acrylate, isocyanate, chloro, or a combination thereof, and wherein R¹¹ is hydrogen, alkyl, aryl, or arylalkylenyl, wherein aryl and arylalkylenyl are unsubstituted or substituted by at least one alkyl, alkoxy, or combination thereof; and
each X is independently hydroxyl or a hydrolysable group.

In a fourteenth embodiment, the present disclosure provides the process, use, or kit of any one of the first to seventh embodiments, wherein the amine-reactive organosilane compound is an epoxy-functional organosilane compound.

In a fifteenth embodiment, the present disclosure provides the process, use, or kit of any one of the first to fourteenth embodiments, wherein the condensation-curable polyorganosiloxane comprises divalent units represented by formula:

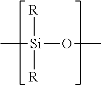

and greater than one —Si(Y)ₚ(R)₃₋ₚ group,
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof;
each Y is independently hydroxyl or a hydrolysable group; and
p is 1, 2, or 3; and
   wherein the amino-functional silane is represented by formula (R⁶)₂N—[R⁴—Z]ᵣ—R⁴—[Si(Y)ₚ(R⁵)₃₋ₚ], and wherein the cyclic azasilane is represented by formula

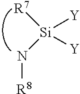

wherein
each R⁴ is independently alkylene, arylene, or alkylene optionally interrupted or terminated by arylene;
R⁵ is alkyl, aryl, arylalkylenyl, or heterocycloalkylenyl, wherein aryl and arylalkylenyl are unsubstituted or substituted by at least one alkyl, alkoxy, or combination thereof,
each Z is independently —O— or —N(R);
each R⁶ is independently hydrogen, alkyl, aryl, arylalkylenyl, or —R⁴—[Si(Y)ₚ(R⁵)₃₋ₚ], wherein aryl and arylalkylenyl are unsubstituted or substituted by at least one alkyl, alkoxy, or combination thereof,
R⁷ is an alkylene having 2 to 5 carbon atoms and is uninterrupted or interrupted by at least one catenated —N(R)—;
each R⁸ is independently hydrogen, alkyl, or alkenyl, wherein alkyl and alkenyl are unsubstituted or substituted by —NR¹R², wherein R¹ and R² are independently hydrogen or alkyl;
each Y is independently hydroxyl or a hydrolyzable group;
r is 0, 1, 2, or 3; and
p is 1, 2, or 3.

In a sixteenth embodiment, the present disclosure provides the process, use, or kit of the fifteenth embodiment, wherein the condensation-curable polyorganosiloxane comprises at least one of at least three —Si(Y)ₚ(R)₃₋ₚ groups or up to six —Si(Y)ₚ(R)₃₋ₚ groups and/or wherein the ratio of divalent units represented by formula:

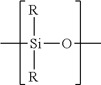

to —Si(Y)ₚ(R)₃₋ₚ groups is at least 4.

In a seventeenth embodiment, the present disclosure provides the process, use, or kit of the fifteenth or sixteenth embodiment, wherein the condensation-curable polyorganosiloxane comprises (m) terminal units represented by formula -Q-Si(Y)ₚ(R)₃₋ₚ and (n) divalent units represented by formula:

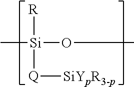

wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof;
each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether, thioether, amine, amide, ester, thioester, carbonate, thiocarbonate, carbamate, thiocarbamate, urea, thiourea, or a combination thereof;
each Y is independently hydroxyl or a hydrolysable group;
p is 1, 2, or 3;
(n) is at least 1; and
(m)+(n) is greater than 2.

In an eighteenth embodiment, the present disclosure provides the process, use, or kit of the seventeenth embodiment, wherein (m)+(n) is in a range from 3 to 6.

In a nineteenth embodiment, the present disclosure provides the process, use, or kit of any one of the first to eighteenth embodiments, wherein the condensation-curable polyorganosiloxane further comprises at least one or two terminal —Si(R)₃ groups, wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

In a twentieth embodiment, the present disclosure provides the process, use, or kit of any one of the first to nineteenth embodiments, wherein each R is independently methyl or phenyl.

In a twenty-first embodiment, the present disclosure provides the process, use, or kit of any one of the first to twentieth embodiments, wherein the condensation-curable polyorganosiloxane has not more than 10 percent by weight units represented by formula RSiO3/2, based on the total weight of the condensation-curable polyorganosiloxane.

In a twenty-second embodiment, the present disclosure provides the process, use, or kit of any one of the first to twenty-first embodiments, wherein the condensation-curable polyorganosiloxane is represented by formula:

(R′)R₂SiO[R₂SiO]_{r′}[((Y)ₚ(R)₃₋ₚSiQ)(R)SiO)_{s′}SiR₂(R′)

wherein
each R¹ is independently R, Y, or a terminal unit represented by formula -Q-Si(Y)ₚ(R)₃₋ₚ;
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof,
each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether, thioether, amine, amide, ester, thioester, carbonate, thiocarbonate, carbamate, thiocarbamate, urea, thiourea, or a combination thereof,
r′+s′ is in a range from 10 to 500, wherein s′ is at least 1; and
each Y is independently hydroxyl or a hydrolyzable group; and
each p is 1, 2, or 3.

In a twenty-third embodiment, the present disclosure provides the process, use, or kit of any one of the first to twenty-second embodiments, wherein the condensation-curable polyorganosiloxane is a linear polyorganosiloxane.

In a twenty-fourth embodiment, the present disclosure provides the process, use, or kit of any one of the first to twenty-third embodiments, wherein the condensation-curable polyorganosiloxane has a molecular weight of at least 300 grams per mole.

In a twenty-fifth embodiment, the present disclosure provides the process, use, or kit of any one of the sixteenth to twenty-fourth embodiments, wherein each Y is independently alkoxy, aryloxy, or acyloxy.

In a twenty-sixth embodiment, the present disclosure provides the process, use, or kit of any one of the sixteenth to twenty-fifth embodiments, wherein each Y is methoxy, and wherein the condensation-curable polyorganosiloxane has a weight percent of methoxy groups of not more than 20 weight percent, based on the total weight of the condensation-curable polyorganosiloxane.

In a twenty-seventh embodiment, the present disclosure provides the process, use, or kit of any one of the first to twenty-sixth embodiments, wherein second composition comprises the amino-functional silane, and wherein the amino-functional silane is 3-aminopropyltrimethoxysilane, 3-aminopropyltriethoxysilane, bis(3-trimethoxysilylpropyl)amine, bis(3-triethoxysilylpropyl)amine, N-methyl-bis(3-trimethoxysilylpropyl)amine, N-methyl-bis(3-triethoxysilylpropyl)amine, [3-(2-aminoethylamino)propyl]trimethoxysilane, 3-[2-(2-aminoethylamino)ethylamino]propyltrimethoxysilane, [3-(2-aminoethylamino)propyl]triethoxysilane, 3-[2-(2-aminoethylamino)ethylamino]propyltriethoxysilane, N,N′-bis[3-trimethoxysilylpropyl]-ethylenediamine, N,N-bis[3-trimethoxysilylpropyl]-ethylenediamine, or a combination thereof.

In a twenty-eighth embodiment, the present disclosure provides the process, use, or kit of any one of the first to twenty-seventh embodiments, wherein the second composition comprises the cyclic azasilane, and wherein the cyclic azasilane is 2,2-dimethoxy-N-butyl-1-aza-2-silacyclopentane, 2-methyl-2-methoxy-N-(2-aminoethyl)-1-aza-2-silacyclopentane, 2,2-diethoxy-N-(2-aminoethyl)-1-aza-2-silacyclopentane, 2,2-dimethyl-N-allyl-1-aza-2-silacyclopentane, 2,2-dimethoxy-N-methyl-1-aza-2-silacyclopentane, 2,2-diethoxy-1-aza-2-silacyclopentane, 2,2-dimethoxy-1,6-diaza-2-silacyclooctane, N-methyl-1-aza-2,2,4-trimethylsilacyclopentane, or a combination thereof.

In a twenty-ninth embodiment, the present disclosure provides the process, use, or kit of any one of the first to twenty-eighth embodiments, wherein the second composition comprises a catalyst, and wherein the catalyst comprises at least one of an organic tin compound, organic titanium compound, organic zirconium compound, organic aluminum compound, an inorganic base, or nitrogen-containing organic base.

In a thirtieth embodiment, the present disclosure provides the process, use, or kit of any one of the first to twenty-ninth embodiments, wherein the second composition further comprises a second polyorganosiloxane comprising divalent units represented by formula:

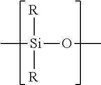

wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof, and wherein the second polyorganosiloxane does not include hydrolyzable groups.

In a thirty-first embodiment, the present disclosure provides the process, use, or kit of the thirtieth embodiment, wherein the second polyorganosiloxane is a polydimethylsiloxane.

In a thirty-second embodiment, the present disclosure provides the process, use, or kit of any one of the first to thirty-first embodiments, wherein the second composition further comprises a further polyorganosiloxane comprising divalent units represented by formula:

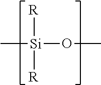

and at least one —Si(Y)ₚ(R)₃₋ₚ group,
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof,
each Y is independently a hydrolyzable group; and
p is 1, 2, or 3.

In a thirty-third embodiment, the present disclosure provides the process, use, or kit of the thirty-second embodiment, wherein the further polyorganosiloxane comprises two -Q-Si(Y)ₚ(R)₃₋ₚ terminal groups,

wherein
each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether, thioether, amine, amide, ester, thioester, carbonate, thiocarbonate, carbamate, thiocarbamate, urea, thiourea, or a combination thereof,
each Y is independently alkoxy, aryloxy, or acyloxy; and
each p is 1, 2, or 3.

In a thirty-fourth embodiment, the present disclosure provides the process, use, or kit of any one of the first to thirty-third embodiments, wherein the second composition further comprises a silane having at least one hydrolyzable group.

In a thirty-fifth embodiment, the present disclosure provides the process, use, or kit of the thirty-fourth embodiment, wherein the silane is represented by formula:

R^{3′}_{f′}[Si(Y)₄₋ₙ]_{g′}

wherein:
g′ is 1 to 6;
f′ is 0, 1 or 2, with the proviso that when f′ is 0, g is 1;
each R^{3′} is monovalent or multivalent, and is independently alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each unsubstituted or substituted with at least one epoxy, thiol, (meth)acrylate, vinyl, allyl, isocyanate, thiocyanate, ureido, chloro, or a combination thereof, and wherein R¹¹ is hydrogen, alkyl, aryl, or arylalkylenyl, wherein aryl and arylalkylenyl are unsubstituted or substituted by at least one alkyl, alkoxy, or combination thereof, and each Y is independently hydroxyl or a hydrolyzable group.

In a thirty-sixth embodiment, the present disclosure provides the process, use, or kit of the thirty-fifth embodiment, wherein f is 1 or 2, and wherein g is 1.

In a thirty-seventh embodiment, the present disclosure provides the process, use, or kit of any one of the thirty-fourth to thirty-sixth embodiments, wherein the silane comprises at least one of methacryloxypropyltrimethoxysilane, 3-glycidoxypropyltrimethoxysilane, isooctyltrimethoxysilane, 3-mercaptopropyltrimethoxysilane, isobutyltrimethoxysilane, or tetraethyl orthosilicate.

In a thirty-eighth embodiment, the present disclosure provides the process, use, or kit of the thirty-fourth embodiment, wherein the silane is represented by formula:

Y—[Si(R^{3c′})(Y)—O]_{r″}—Si(R^{3c′})(X)₂

wherein:
r″ is 1 to 20;
each R^{3c′} is independently monovalent alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein alkyl, aryl, and arylalkylenyl are each unsubstituted or substituted with at least one amino, epoxy, thiol, (meth)acrylate, vinyl, allyl, isocyanate, thiocyanate, ureido, chloro, or a combination thereof, and wherein R¹¹ is hydrogen, alkyl, aryl, or arylalkylenyl, wherein aryl and arylalkylenyl are unsubstituted or substituted by at least one alkyl, alkoxy, or combination thereof, and
each Y is independently hydroxyl or a hydrolysable group.

In a thirty-ninth embodiment, the present disclosure provides the process, use, or kit of any one of the first to thirty-eighth embodiments, wherein the second composition is essentially free of fluorinated silanes.

In a fortieth embodiment, the present disclosure provides the process, use, or kit of any one of the first to thirty-ninth embodiments, further comprising at least one non-halogenated organic solvent.

In a forty-first embodiment, the present disclosure provides the process, use, or kit of any one of the first to thirty-ninth embodiments, wherein the second composition comprises not more than 20 weight percent organic solvent, based on the total weight of the second composition.

In a forty-second embodiment, the present disclosure provides the process, use, or kit of any one of the first to thirty-fourth embodiments, wherein the second composition comprises not more than five percent by weight water, based on the total weight of the second composition.

In a forty-third embodiment, the present disclosure provides the process, use, or kit of any one of the first to forty-second embodiments, wherein the second composition further comprises water and at least one of a nonionic surfactant or an anionic surfactant.

In a forty-fourth embodiment, the present disclosure provides the process, use, or kit of the forty-third embodiment, wherein the second composition is an oil-in-water emulsion.

In a forty-fifth embodiment, the present disclosure provides the process of any one of the first to forty-fourth embodiments, further comprising removing a portion of the second composition from the siliceous substrate before allowing the second composition to fully cure.

In a forty-sixth embodiment, the present disclosure provides the process of any one of the first to forty-fifth embodiments, further composition allowing the second composition to at least partially cure at room temperature.

In a forty-seventh embodiment, the present disclosure provides a coated article made by the process of any one of the first to forty-seventh embodiments.

In a forty-eighth embodiment, the present disclosure provides the coated article of the forty-seventh embodiment, having a receding contact angle of greater than 80 after 2000 scrubs (made according to the Coated Glass Plate Scrub Test Method in the Examples Section).

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise stated, all amounts are in weight percent (wt. %).

TABLE 1
Materials List.

| Abbreviation | |
|---|---|
| or Trade Name | Description |
| Glass plate | 4 inch × 5.875 inch × 0.1875 inch |
| | (10.2 cm × 14.9 cm × 0.48 cm) soda-lime |
| | float glass available from Northwestern Glass |
| | Fab, Fridley, Minn. |
| 3M 60150 | 3M Glass Polishing Compound available from |
| | 3M Company, Maplewood, Minn. |
| 3M 08888 | 3M Glass Cleaner available from 3M Company |
| 3M 06082 | 3M Inspection Spray available from 3M |
| | Company |
| 3M 39903 | A solution of partially hydrolyzed 3- |
| | glycidoxypropyl-trimethoxysilane in |
| | isopropanol available from 3M Company |
| 2-propanol, 70% | Available from VWR, International Batavia, |
| | Ill. |
| 3M 39016 | Microfiber Detail Cloth available from 3M |
| | Company |
| TMS C50 | Silmer TMS C50 is a 100% active trialkoxy |
| | functional cross-linking silicone, with the |
| | formula (CH₃)₃SiO—[Si(CH₃){CH₂—CH₂— |
| | Si(OCH₃)₃}—O]_{3.1}—[Si(CH₃)₂— |
| | O]_{145.1}—Si(CH₃)₃, as determined from NMR |
| | spectroscopy, available from Siltech Corp., Toronto, |
| | Ontario, Canada. |
| OFS-2306 | Isobutyltrimethoxysilane from Dow Corning, |
| | Midland,Mich. |
| Kkat | A zinc-based silane condensation catalyst from |
| | King Industries Norwalk, Connecticut, under the |
| | trade designation “Kkat 670”. |
| A-1170 | Bis(trimethoxysilylpropyl)amine available |
| | from Momentive Performance Materials, Friendly, |
| | West Virginia |

### Examples 1 and 2 and Illustrative Examples (Ill. Ex.) 1 to 4

### Glass Polishing and Cleaning

Six glass plates purchased from Northwestern Glass Fab were prepared for treatment and coating. First, the tin side of the glass was identified by illuminating the glass with a black light and was permanently marked. All further operations described below were applied to the tin side of the glass plates. The glass was next polished using 3M 60150 Glass Polishing Compound. About 4 grams (g) of the compound was applied to a Meguiar's DFF5 polishing pad fitted to a Meguiar's MT300 dual action polisher. The glass was polished for one minute at a tool speed of 4800 rpm. After polishing, the glass was cleaned sequentially with 3M Glass Cleaner 08888, 3M Inspection Spray 06082, and 2-propanol, 70%.

Glass Plate Treatment with First Composition

After cleaning, the glass was moved to a constant temperature and humidity room maintained at 73° F. (23° C.) and 50% relative humidity. Three of the six plates were pre-treated with “3M 39903” as shown in Table 2 below.

TABLE 2
Glass Plate Treatment with First Composition

| | 3M 39903 |
|---|---|
| Example Number | treatment |
| Ill. Ex. 1 | No |
| Ex. 1 | Yes |
| Ill. Ex. 2 | No |
| Ex. 2 | Yes |
| Ill. Ex. 3 | No |
| Ill. Ex. 4 | Yes |

The 3M 39903 composition was applied to the glass plates of Examples 1 and 2 and Illustrative Example 4 using a 4 inch×8 inch (10.2 centimeters (cm)×20.3 cm) microfiber cloth cut from a 3M 39016 detailing cloth. Two finger pump sprays were applied both to the cloth and to the glass surface from a bottle of 3M 39903. The 3M 39903 was spread across the plate continuously for 30 seconds and then wiped with a clean, dry 3M 39016 detailing cloth to remove any excess. Treating of all three plates was completed in less than about 5 minutes.

Glass Plate Treatment with Second Composition

The six glass plates above were coated with the second compositions having the formulations shown in Table 3 below within 15 minutes of the 3M 39903 treatment. The second compositions were applied to the glass plates using a 4 inch×8 inch (10.2 cm×20.3 cm) microfiber cloth cut from a 3M 39016 detailing cloth. About 0.7 g of the composition was applied dropwise to the cloth and then spread over the surface of the glass plate for 30 seconds. After a total of two minutes, the excess coating was removed with a clean, dry 39016 Microfiber Detail Cloth and hand buffed lightly to a high gloss. This was repeated for the remaining 5 examples. The treated glass plates were allowed to cure in the 73° F. (23° C.)/50% relative humidity environment for 1 hour. Then, another coating was applied to each of the glass plates directly over the first coating using the same application procedure as the first. In all cases, the formulation of the second coating of the second composition applied to each glass plate is the same as that used for the first coating of the second composition. All glass plates were left to cure in the 73° F. (23° C.)/50% relative humidity environment for about 5 days before testing.

TABLE 3
Second Composition Formulations

| Component | Ill. Ex. 1 | Ex. 1 | Ill. Ex. 2 | Ex. 2 | Ill. Ex. 3 | Ill. Ex. 4 |
|---|---|---|---|---|---|---|
| TMS C50 (g) | 29.71 | 29.71 | 29.90 | 29.90 | 30.85 | 30.85 |
| OFS-2306 (g) | 7.76 | 7.76 | 7.76 | 7.76 | 7.76 | 7.76 |
| A-1170 (g) | 1.14 | 1.14 | 1.14 | 1.14 | 0 | 0 |
| Kkat (g) | 0.19 | 0.19 | 0 | 0 | 0.19 | 0.19 |

### Fluid Contact Angle Test Method

After curing for 5 days, water contact angles of each sample were measured using a Ramé-Hart goniometer (Ramé-Hart Instrument Co., Succasunna, New Jersey). Initial static (θₛₜₐ), advancing (θ_{adv}) and receding (θ_{rec}) angles were measured using deionized water supplied via a syringe into or out of sessile droplets (drop volume about 5 μL). Measurements were taken near the center of each coated glass test panel. Reported measurements are averages of three values for each sample with each measurement itself representing an average of both the left and right side of each drop. After measuring and recording initial contact angle measurements, the coated glass plates were scrubbed to determine the relative durability of the coatings as described below.

### Coated Glass Plate Scrub Method

Coated glass plate scrub testing was performed using a BYK Gardner Scrub machine, available from BYK Gardner USA, recirculated water and a section of automotive windshield wiper. A glass plate holder was fashioned from a sturdy aluminum baking sheet by securing two similar pieces of glass to the base of the baking sheet with thermosetting urethane marine adhesive. A 4-inch (10.6-cm) gap was left between the adhered glass pieces to accommodate the test piece. Tap water is recirculated and sprayed to the test plate continuously during testing to simulate rainwater. The baking sheet was fitted with two drain holes opposite the glass plates. These drained to a tub containing a submersible pump that recirculated water to the glass test plate. The scrub machine was equipped with a custom windshield wiper holder attachment. The length of wiper used was 14.5 cm and the total weight of the fixture 237 g providing about 16.3 g_{f}/cm which matches design of automotive wiper installations on passenger vehicles. A new piece of Vorcool natural rubber, frameless wiper blade X001YPSNAD was used for each glass test plate. The reciprocation speed of the BYK Gardner Scrub was set at 40 cycles/minute and for a total of 2000 cycles on each glass plate sample. After scrubbing, each sample plate was rinsed with tap water and blown dry with dry house nitrogen. Then, using the same fluid contact angle procedure described above, advancing and receding water contact angle measurements were made and recorded. Initial and after scrub contact angle data is shown in Table 4, below.

TABLE 4
Initial and After Scrub Water Contact Angle Measurements

| | Ill. | | Ill. | | Ill. | Ill. |
|---|---|---|---|---|---|---|
| | Ex. 1 | Ex. 1 | Ex. 2 | Ex. 2 | Ex. 3 | Ex. 4 |
| Static CA (°) Initial | 102.1 | 102.0 | 102.8 | 102.5 | 103.4 | 101.3 |
| Static CA (°) After Scrub | 87.4 | 95.4 | 87.7 | 82.7 | 69.5 | 71.2 |
| Advancing CA (º) Initial | 108.1 | 108.3 | 107.1 | 106.9 | 106.7 | 107.0 |
| Advancing CA (°) After Scrub | 98.3 | 100.1 | 92.9 | 89.6 | 76.7 | 77.5 |
| Receding CA (°) Initial | 102.5 | 100.6 | 100.5 | 100.9 | 100.1 | 97.5 |
| Receding CA (°) After Scrub | 75.8 | 83.9 | 67.9 | 61.9 | 44.4 | 43.6 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A process for making a coated article, the process comprising:
applying a first composition on at least the portion of a siliceous substrate, the first composition comprising an amine-reactive organosilane compound, wherein the amine-reactive organosilane compound is at least partially hydrolyzed; and subsequently
applying a second composition on at least a portion of the first composition, the second coating composition comprising at least one of an amino-functional silane or cyclic azasilane and a condensation-curable polyorganosiloxane having divalent units represented by formula 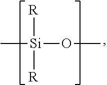
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

2. The process of claim 1, wherein the condensation-curable polyorganosiloxane in the second coating composition comprises more than one functional group selected from the group consisting of silanol, hydrolyzable silane, or a combination thereof.

3. The process of claim 1, further comprising a catalyst for at least one of hydrolyzing hydrolyzable groups in at least one of the condensation-curable polyorganosiloxane, amino-functional silane, or cyclic azasilane or condensing silanol groups to form siloxane bonds.

4. The process of claim 1, wherein the siliceous substrate comprises automotive glass.

5. The process of claim 1, wherein the first composition and second composition do not change the appearance of the siliceous substrate.

6. The process of claim 1, wherein the condensation-curable polyorganosiloxane comprises:
divalent units represented by formula: 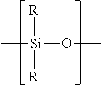
and greater than one —Si(Y)ₚ(R)₃₋ₚ group,
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof;
each Y is independently hydroxyl or a hydrolysable group; and
p is 1, 2, or 3; and
wherein the amino-functional silane is represented by formula (R⁶)₂N—[R⁴—Z]ᵣ—R⁴—[Si(Y)ₚ(R⁵)₃₋ₚ], and wherein the cyclic azasilane represented by formula 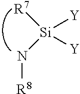
wherein
each R⁴ is independently alkylene, arylene, or alkylene optionally interrupted or terminated by arylene;
R⁵ is alkyl, aryl, arylalkylenyl, or heterocycloalkylenyl, wherein aryl and arylalkylenyl are unsubstituted or substituted by at least one alkyl, alkoxy, or combination thereof,
each Z is independently —O— or —N(R⁶)—;
each R⁶ is independently hydrogen, alkyl, aryl, arylalkylenyl, or —R⁴—[Si(Y)ₚ(R⁵)₃₋ₚ], wherein aryl and arylalkylenyl are unsubstituted or substituted by at least one alkyl, alkoxy, or combination thereof,
R⁷ is an alkylene having 2 to 5 carbon atoms and is uninterrupted or interrupted by at least one catenated —N(R⁸)—;
each R⁸ is independently hydrogen, alkyl, or alkenyl, wherein alkyl and alkenyl are unsubstituted or substituted by —NR¹R², wherein R¹ and R² are independently hydrogen or alkyl;
each Y is independently hydroxyl or a hydrolyzable group;
r is 0, 1, 2, or 3; and
p is 1, 2, or 3.

7. The process of claim 6, wherein the condensation-curable polyorganosiloxane comprises (m) terminal units represented by formula -Q-Si(Y)ₚ(R)₃₋ₚ and (n) divalent units represented by formula: 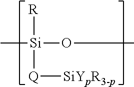
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof;
each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether, thioether, amine, amide, ester, thioester, carbonate, thiocarbonate, carbamate, thiocarbamate, urea, thiourea, or a combination thereof;
each Y is independently hydroxyl or a hydrolysable group;
p is 1, 2, or 3;
(n) is at least 1; and
(m)+(n) is greater than 2.

8. The process of claim 6, wherein each Y is methoxy, and wherein the condensation-curable polyorganosiloxane has a weight percent of methoxy groups of not more than 20 weight percent, based on the total weight of the polyorganosiloxane.

9. The process of claim 1, wherein the amino-functional silane is 3-aminopropyltrimethoxysilane, 3-aminopropyltriethoxysilane, bis(3-trimethoxysilylpropyl)amine, bis(3-triethoxysilylpropyl)amine, N-methyl-bis(3-trimethoxysilylpropyl)amine, N-methyl-bis(3-triethoxysilylpropyl)amine, [3-(2-aminoethylamino)propyl]trimethoxysilane, 3-[2-(2-aminoethylamino)ethylamino]propyltrimethoxysilane, [3-(2-aminoethylamino)propyl]triethoxysilane, 3-[2-(2-aminoethylamino)ethylamino]propyltriethoxysilane, N,N′-bis[3-trimethoxysilylpropyl]-ethylenediamine, N,N-bis[3-trimethoxysilylpropyl]-ethylenediamine, or a combination thereof, and wherein the cyclic azasilane is 2,2-dimethoxy-N-butyl-1-aza-2-silacyclopentane, 2-methyl-2-methoxy-N-(2-aminoethyl)-1-aza-2-silacyclopentane, 2,2-diethoxy-N-(2-aminoethyl)-1-aza-2-silacyclopentane, 2,2-dimethyl-N-allyl-1-aza-2-silacyclopentane, 2,2-dimethoxy-N-methyl-1-aza-2-silacyclopentane, 2,2-diethoxy-1-aza-2-silacyclopentane, 2,2-dimethoxy-1,6-diaza-2-silacyclooctane, N-methyl-1-aza-2,2,4-trimethylsilacyclopentane, or a combination thereof.

10. The process of claim 1, wherein the amine-reactive organosilane compound is represented by formula:
R³_{f}[Si(X)_{4-f}]_{g}
wherein:
g is 1 to 6;
f is 1 or 2;
each R³ is monovalent or multivalent and is independently alkyl, aryl, or arylalkylenyl, wherein alkyl and arylalkylenyl are each uninterrupted or interrupted with at least one catenated —O—, —N(R¹¹)—, —S—, —P—, —Si— or combination thereof, wherein aryl and arylalkylenyl are each unsubstituted or substituted by alkyl or alkoxy, and wherein at least one R³ is substituted with at least one epoxy, (meth)acrylate, isocyanate, chloro, or a combination thereof, and wherein R¹¹ is hydrogen, alkyl, aryl, or arylalkylenyl, wherein aryl and arylalkylenyl are unsubstituted or substituted by at least one alkyl, alkoxy, or combination thereof; and
X is independently hydroxyl or a hydrolyzable group, with the proviso that at least one X is hydroxyl.

11. The process of claim 1, wherein the amine-reactive organosilane compound is an epoxy-functional organosilane compound.

12. The process of claim 1, wherein the second composition is essentially free of fluorinated silanes.

13. (canceled)

14. A kit comprising:
a container comprising a first composition comprising an at least partially hydrolyzed amine-reactive organosilane compound; and
a container comprising a second composition comprising at least one of an amino-functional silane or cyclic azasilane and a condensation-curable polyorganosiloxane having divalent units represented by formula 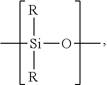
wherein
each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

15. A coated article made by the process of claim 1.

16. The process of claim 10, wherein f is 1, and wherein g is 1.

17. The process of claim 7, wherein (m)+(n) is in a range from 3 to 6.

18. The process of claim 6, wherein the condensation-curable polyorganosiloxane further comprises at least one or two terminal —Si(R)₃ groups, wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof.

19. The process of claim 6, wherein the wherein the second composition comprises a catalyst, and wherein the catalyst comprises at least one of an organic tin compound, organic titanium compound, organic zirconium compound, organic aluminum compound, an inorganic base, or nitrogen-containing organic base.

20. The process of claim 1, wherein the second composition further comprises a second polyorganosiloxane comprising divalent units represented by formula: 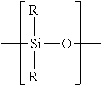
wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R¹¹)—, or combination thereof, wherein aryl, arylalkylenyl, and heterocycloalkyenyl are unsubstituted or substituted by at least one alkyl, alkoxy, halogen, or combination thereof, and wherein R¹¹ is hydrogen, alkyl, aryl, or arylalkylenyl, wherein aryl and arylalkylenyl are unsubstituted or substituted by at least one alkyl, alkoxy, or combination thereof, and wherein the second polyorganosiloxane does not include hydrolyzable groups.

21. The process of claim 1, wherein each R is independently methyl or phenyl.
